(19) United States
(12) Patent Application Publication
(10) Pub. No.: US 2019/0090287 A1
(43) Pub. Date: Mar. 21, 2019

(54) PERFORMING PROPRIETARY LINK LAYER CONTROL PROCEDURES WITH A PROPRIETARY DEVICE

(71) Applicant: QUALCOMM Incorporated, San Diego, CA (US)

(72) Inventors: Brian REDDING, Urbana, IL (US); Robin HEYDON, Cambridge (GB); Joel LINSKY, San Diego, CA (US)

(21) Appl. No.: 15/709,279

(22) Filed: Sep. 19, 2017

(51) Int. Cl. H04W 76/02; H04W 4/00; H04W 76/06; H04W 12/04

(52) U.S. Cl. CPC H04W 76/023; H04W 4/008; H04W 80/02; H04W 12/04; H04W 76/064

(57) ABSTRACT

In an aspect of the disclosure, a method, a computer-readable medium, and an apparatus are provided. The apparatus may establish a non-proprietary short-range link layer connection with a second device. The apparatus may establish a proprietary link layer connection with the second device. The apparatus may determine a duration of a previous non-proprietary link layer connection event. The apparatus may determine a number of proprietary link layer control PDUs to be exchanged during a proprietary connection event based at least in part on the duration of the previous non-proprietary link layer connection event and a start time of a subsequent non-proprietary link layer connection event. The apparatus may perform a proprietary control procedure by exchanging the number of proprietary link layer PDUs with the second device during the proprietary connection event.

### BACKGROUND

### Field

The present disclosure relates generally to communication systems, and more particularly, to perform proprietary link layer (QLL) control procedures with a peer proprietary device.

### Background

A wireless personal area network (WPAN) is a personal, short-range area wireless network for interconnecting devices centered around a specific distance from a user. WPANs have gained popularity because of the flexibility and convenience in connectivity that WPANs provide. WPANs, such as those based on short-range communication protocols (e.g., a Bluetooth® (BT) protocol, BT low-energy (BLE) protocol, a Zigbee® protocol, etc.), provide wireless connectivity to peripheral devices by providing short-range wireless links that allow connectivity within a specific distance (e.g., 5 meters, 10 meter, 20 meters, 100 meters, etc.).

BT is a short-range wireless communication protocol that supports a WPAN between a central device (e.g., a master device) and at least one peripheral device (e.g., a slave device). Power consumption associated with BT communications may render BT impractical in certain applications, such as applications in which an infrequent transfer of data occurs.

To address the power consumption issue associated with BT, BLE was developed and adopted in various applications in which an infrequent transfer of data occurs. BLE exploits the infrequent transfer of data by using a low duty cycle operation, and switching at least one of the central device and/or peripheral device(s) to a sleep mode in between data transmissions. A BLE communications link between two devices may established using, e.g., hardware, firmware, host operating system, host software stacks, and/or host application support. Example applications that use BLE include battery-operated sensors and actuators in various medical, industrial, consumer, and fitness applications that connect to devices such as BLE enabled smart phones, tablets, and laptops. While traditional BLE offers certain advantages, there exists a need for further improvements in BLE technology.

For example, in certain scenarios establishing a QLL communication link between two proprietary devices that is independent of the hardware, firmware, host operating system, host software stacks, and/or host application support may be desirable. By establishing a QLL communication link that is independent of the hardware, firmware, host operating system, host software stacks, and/or host application support, services such as firmware updates, licensing additional codes, and/or adding additional firmware components on peer devices with minimal peer host software support may be supported.

Thus, there exists a need to establish a QLL communication link between two proprietary devices that is independent of the hardware, firmware, host operating system, host software stacks, and/or host application support, and to perform QLL control procedures associated with the QLL communication link.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

BLE was developed and adopted in various applications in which an infrequent transfer of data occurs. BLE exploits the infrequent transfer of data by using a low duty cycle operation, and switching at least one of the central device and/or peripheral device(s) to a sleep mode in between data transmissions. A BLE communications link between two devices may established using, e.g., hardware, firmware, host operating system, host software stacks, and/or host application support. Example applications that use BLE include battery-operated sensors and actuators in various medical, industrial, consumer, and fitness applications that connect to devices such as BLE enabled smart phones, tablets, and laptops. While traditional BLE offers certain advantages, there exists a need for further improvements in BLE technology.

For example, in certain scenarios it may be beneficial to establish a QLL communication link between two proprietary devices that is independent of the hardware, firmware, host operating system, host software stacks, and/or host application support. By establishing a QLL communication link that is independent of the hardware, firmware, host operating system, host software stacks, and/or host application support, services such as firmware updates, licensing additional codes, and/or adding additional firmware components on peer devices with minimal peer host software support may be supported.

Thus, there exists a need for a technique to establish a QLL communication link between two proprietary devices that is independent of the hardware, firmware, host operating system, host software stacks, and/or host application support, and to perform QLL control procedures associated with the QLL communication link.

The present disclosure provides a QLL protocol that exists alongside of the Link Layer (LL) in a modified BLE protocol stack. The QLL protocol may be used to discover other proprietary devices. The QLL protocol may also be used to establish a secure QLL communication link with another proprietary device that is independent of the hardware, firmware, host operating system, host software stacks, and/or host application support in order to support services such as firmware updates, licensing additional codes, and/or adding additional firmware components. In addition, the QLL protocol may be used to perform QLL control procedures associated with the QLL communication link. Examples of QLL control procedures include QLL service discovery and identification of a peer proprietary controller, a determination of QLL channels, a determination of QLL features supported between two proprietary controllers, QLL security management procedures, and/or a termination of a QLL communication link, just to name a few.

In an aspect of the disclosure, a method, a computer-readable medium, and an apparatus are provided. The apparatus may establish a non-proprietary short-range link layer connection with a second device. The apparatus may establish a proprietary link layer connection with the second device. The apparatus may determine a duration of a previous non-proprietary link layer connection event. The apparatus may determine a number of proprietary link layer control protocol data units (PDUs) to be exchanged during a proprietary connection event based at least in part on the duration of the previous non-proprietary link layer connection event and a start time of a subsequent non-proprietary link layer connection event. The apparatus may perform a proprietary control procedure by exchanging the number of proprietary link layer PDUs with the second device during the proprietary connection event.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a WPAN in accordance with certain aspects of the disclosure.

FIG. 2 is block diagram of a BLE device in accordance with certain aspects of the disclosure.

FIG. 3 is a diagram illustrating a modified BLE protocol stack that may include a QLL in accordance with certain aspects of the disclosure.

FIG. 4A illustrates a data flow that may be used to establish a QLL communication link in accordance with certain aspects of the disclosure.

FIG. 4B illustrates a QLL establishment protocol that may be used to establish a QLL communication link by exchanging a particular sequence of QLL establishment PDUs in accordance with certain aspects of the disclosure.

FIG. 4C illustrates a data flow that may be used to perform QLL control procedures in accordance with certain aspects of the disclosure.

FIG. 4D illustrates a QLL key challenge protocol that may be used to verify an encryption key used during data communication via a QLL communication link in accordance with certain aspects of the disclosure.

FIG. 4E illustrates a QLL termination protocol that may be used to terminate a QLL communication link in accordance with certain aspects of the disclosure.

FIGS. 5A and 5B are a flowchart of a method of wireless communication.

FIG. 6 is a conceptual data flow diagram illustrating the data flow between different means/components in an exemplary apparatus.

FIG. 7 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

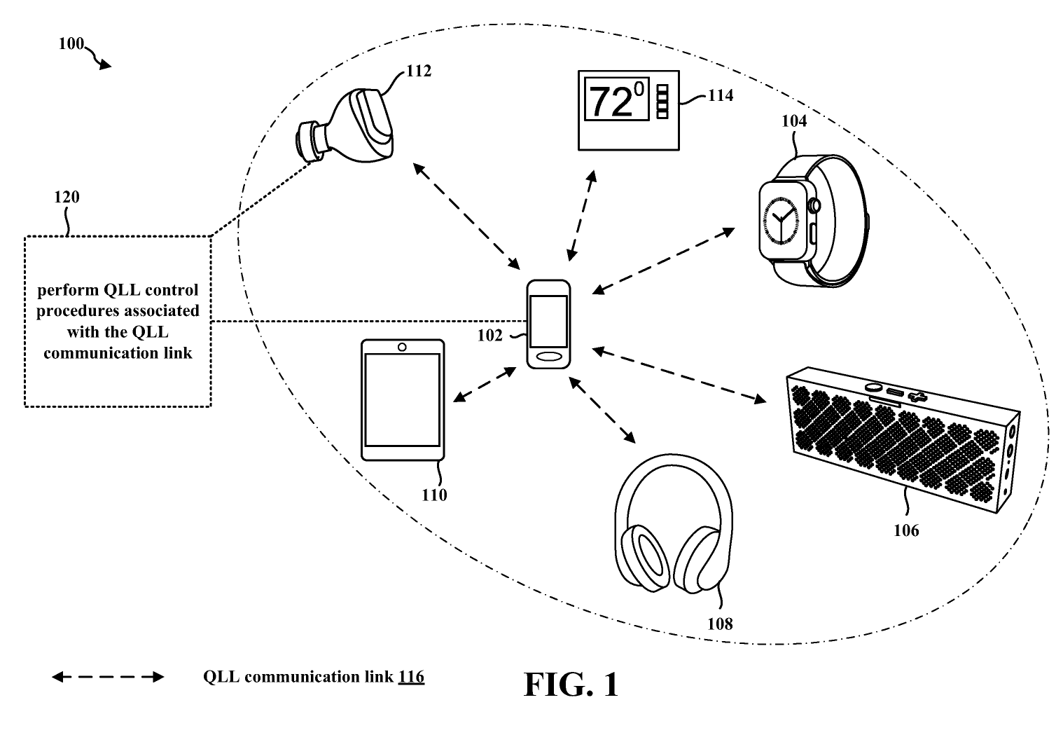

FIG. 1 illustrates an example WPAN 100 in accordance with certain aspects of the disclosure. Within the WPAN 100, a central device 102 may connect to and establish a QLL communication link 116 with one or more peripheral devices 104, 106, 108, 110, 112, 114 using a modified BLE protocol. The BLE protocol is a specification that enables radio frequency communication operating within the globally accepted 2.4 GHz Industrial, Scientific & Medical (ISM) band.

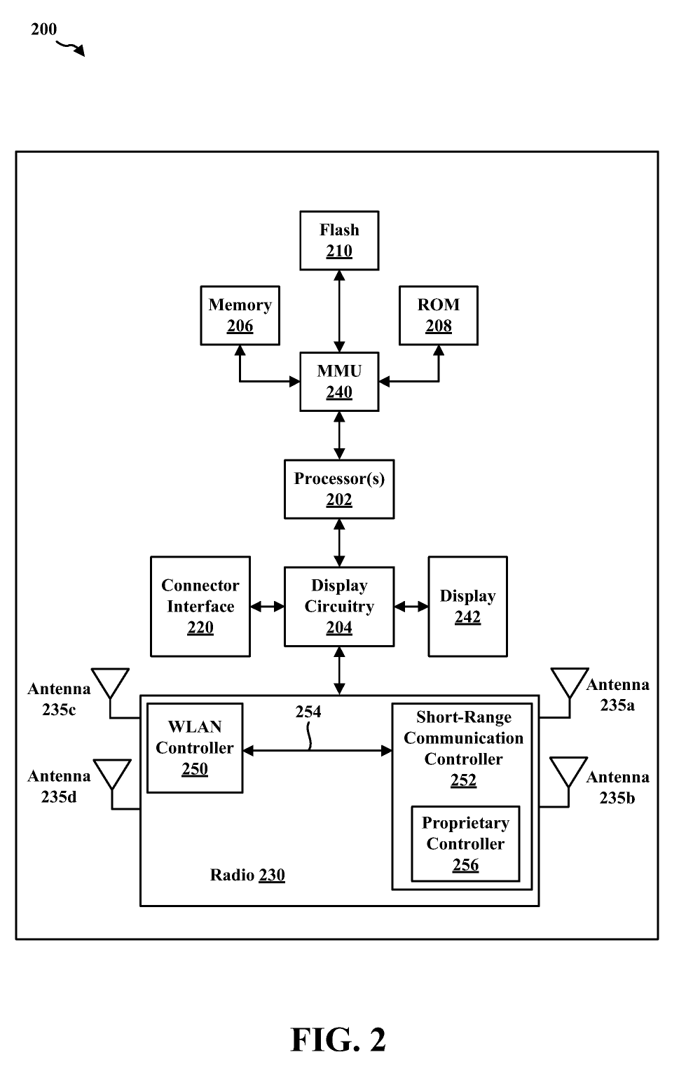

The central device 102 may comprise suitable logic, circuitry, interfaces, processors, and/or code that may be used to communicate with one or more peripheral devices 104, 106, 108, 110, 112, 114 using the BLE protocol or the modified BLE protocol as described below with reference to FIGS. 2-7. The central device 102 may operate as an initiator to request establishment of a LL connection with an intended peripheral device 104, 106, 108, 110, 112, 114. Either the central device 102 (master device) or a peripheral device 104, 106, 108, 11, 112, 114 (slave device) may be an initiator of a QLL control procedure. Similarly, either the central device 102 (master device) or the peripheral device 104, 106, 108, 110, 112, 114 (slave device) may be a responder during a QLL control procedure.

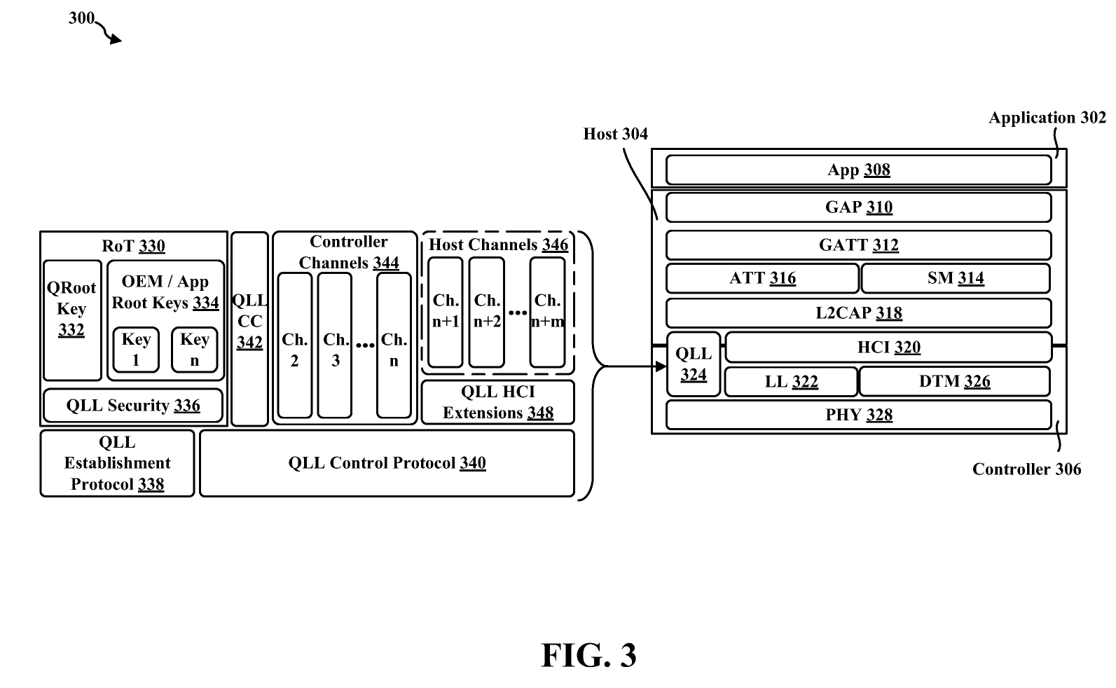

A LL in the BLE protocol stack (e.g., see FIG. 3) provides, as compared to BT, ultra-low power idle mode operation, simple device discovery and reliable point-to-multipoint data transfer with advanced power-save and encryption functionalities. After a requested LL connection is established, the central device 102 may become a master device and the intended peripheral device 104, 106, 108, 110, 112, 114 may become a slave device for the established LL connection. As a master device, the central device 102 may be capable of supporting multiple LL connections at a time to various peripheral devices 104, 106, 108, 110, 112, 114 (slave devices). The central device 102 (master device) may be operable to manage various aspects of data packet communication in a LL connection with an associated peripheral device 104, 106, 108, 110, 112, 114 (slave device). For example, the central device 102 may be operable to determine an operation schedule in the LL connection with a peripheral device 104, 106, 108, 110, 112, 114 (slave device). The central device 102 may be operable to initiate a LL data protocol data unit (PDU) exchange sequence in the LL connection. LL connections may be configured to run periodic connection events in dedicated data channels. The exchange of LL data PDU transmissions between the central device 102 and one or more of the peripheral devices 104, 106, 108, 110, 112, 114 may take place within connection events.

In certain configurations, the central device 102 may be configured to transmit the first LL data PDU in each connection event to an intended peripheral device 104, 106, 108, 110, 112, 114. In certain configurations, the central device 102 may utilize a polling scheme to poll the intended peripheral device 104, 106, 108, 110, 112, 114 for a LL data PDU transmission in a connection event. The intended peripheral device 104, 106, 108, 110, 112, 114 may transmit a LL data PDU upon receipt of packet LL data PDU from the central device 102. In certain other configurations, a peripheral device 104, 106, 108, 110, 112, 114 may transmit a LL data PDU to the central device 102 without first receiving a LL data PDU from the central device 102.

Once a LL connection has been established between the central device 102 (master device) and a peripheral device 104, 106, 108, 110, 112, 114 (slave device), the central device 102 may establish a QLL communication link when the peripheral device 104, 106, 108, 110, 112, 114 is a peer proprietary device. In certain aspects peer proprietary devices may be wireless devices that are both associated with the same company (e.g., Qualcomm®, Apple®, Samsung®, etc.). The QLL communication link 116 may be used to support, e.g., firmware updates, licensing additional codes, adding additional firmware components, and/or updating the operating system, just to name a few.

Examples of the central device 102 include a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, a thermostat, a hearing aid, a blood glucose on-body unit, an Internet-of-Things (IoT) device, or any other similarly functioning device.

Examples of the one or more peripheral devices 104, 106, 108, 110, 112, 114 include a cellular phone, a smart phone, a SIP phone, a STA, a laptop, a PC, a desktop computer, a PDA, a satellite radio, a global positioning system, a multimedia device, a video device, a digital audio player (e.g., MP3 player), a camera, a game console, a tablet, a smart device, a wearable device, a vehicle, an electric meter, a gas pump, a toaster, a thermostat, a hearing aid, a blood glucose on-body unit, an IoT device, or any other similarly functioning device. Although the central device 102 is illustrated in communication with six peripheral devices 104, 106, 108, 110, 112, 114 in the WPAN 100, the central device 102 may communicate with more or fewer than six peripheral devices within the WPAN 100 without departing from the scope of the present disclosure.

Referring again to FIG. 1, in certain aspects, one or more of the central device 102 and/or a peripheral device 104, 106, 108, 110, 112, 114 may be configured to perform (at 120) QLL control procedures associated with the QLL communication link 116.

FIG. 2 is block diagram of a wireless device 200 in accordance with certain aspects of the disclosure. The wireless device 200 may correspond to, e.g., the central device 102, and/or one of the peripheral devices 104, 106, 108, 110, 112, 114 in FIG. 1. In certain configurations, the wireless device 200 may be, e.g., a BLE device that is configured to implemented the modified BLE protocol stack described below with reference to FIG. 3.

As shown in FIG. 2, the wireless device 200 may include a processing element, such as processor(s) 202, which may execute program instructions for the wireless device 200. The wireless device 200 may also comprise display circuitry 204 which may perform graphics processing and provide display signals to the display 242. The processor(s) 202 may also be coupled to memory management unit (MMU) 240, which may be configured to receive addresses from the processor(s) 202 and translate the addresses to locations in memory (e.g., memory 206, ROM 208, Flash memory 210) and/or to other circuits or devices, such as the display circuitry 204, radio 230, connector interface 220, and/or display 242. The MMU 240 may be configured to perform memory protection and page table translation or set up. In some embodiments, the MMU 240 may be included as a portion of the processor(s) 202.

As shown, the processor(s) 202 may be coupled to various other circuits of the wireless device 200. For example, the wireless device 200 may include various types of memory, a connector interface 220 (e.g., for coupling to the computer system), the display 242, and wireless communication circuitry configured to implement the modified BLE protocol stack described below with reference to FIG. 3. The wireless device 200 may include a plurality of antennas 235a, 235b, 235c, 235d, for performing wireless communication with, e.g., BLE devices, peer proprietary device, etc.

In certain aspects, the wireless device 200 may include hardware and software components (a processing element) configured to perform QLL control procedures, e.g., using the techniques described below with reference to FIGS. 3-7. The wireless device 200 may also comprise BLE firmware or other hardware/software for controlling the BLE operations, e.g., described below with reference to FIGS. 3-7. In addition, the wireless device 200 may store and execute a wireless local area network (WLAN) software driver for controlling WLAN operations, and/or a cellular software driver for controlling cellular operations.

The wireless device 200 may be configured to implement part or all of the techniques described below with reference to FIGS. 3-7, e.g., by executing program instructions stored on a memory medium (e.g., a non-transitory computer-readable memory medium) and/or through hardware or firmware operation. In other embodiments, the techniques described below with reference to FIGS. 3-7 may be at least partially implemented by a programmable hardware element, such as an field programmable gate array (FPGA), and/or as an application specific integrated circuit (ASIC).

In certain aspects, radio 230 may include separate controllers configured to control communications for various respective radio access technology (RAT) protocols. For example, as shown in FIG. 2, radio 230 may include a WLAN controller 250 configured to control WLAN communications and a short-range communications controller 252 configured to control short-range communications (e.g., BLE communications). The short-range communications controller 252 may include or be connected with a proprietary controller 256. In certain aspects, the proprietary controller 256 may be associated with a particular company (e.g., Qualcomm®, Apple®, Samsung®, etc.). In certain aspects, the proprietary controller 256 may be configured to establish a QLL communication link between two proprietary devices that is independent of the hardware, firmware, host operating system, host software stacks, and/or host application support. In certain other aspects, the proprietary controller 256 may be a Qualcomm® proprietary controller 256 that is configured to perform QLL control procedures with a peer proprietary device. A coexistence interface 254 (e.g., a wired interface) may be used for sending information between the WLAN controller 250 and the short-range communications controller 252/proprietary controller 256.

In some aspects, one or more of the WLAN controller 250, the short-range communications controller 252, and/or the proprietary controller 256 may be implemented as hardware, software, firmware or some combination thereof.

In certain aspects, the WLAN controller 250 may be configured to communicate with a second device using a WLAN link using all of the antennas 235a, 235b, 235c, 235d. In certain configurations, the short-range communications controller 252 and/or the proprietary controller 256 may be configured to implement a modified BLE protocol stack (see FIG. 3), and communicate with at least one second device using one or more of the antennas 235a, 235b, 235c, 235d.

FIG. 3 illustrates a modified BLE protocol stack 300 that may be implemented in a BLE device in accordance with certain aspects of the present disclosure. For example, the modified BLE protocol stack 300 may be implemented by, e.g., one or more of processor(s) 202, memory 206, Flash memory 210, ROM 208, the radio 230, the short-range communications controller 252, and/or the proprietary controller 256 illustrated in FIG. 2.

Referring to FIG. 3, the modified BLE protocol stack 300 may be organized into three blocks, namely, the Application block 302, the Host block 304, and the Controller block 306. Application block 302 may include the user application which interfaces with the other blocks and/or layers of the modified BLE protocol stack 300. The Host block 304 may include the upper layers of the modified BLE protocol stack 300, and the Controller block 306 may include the lower layers of the modified BLE protocol stack 300.

The Host block 304 may communicate with a controller (e.g., short-range communications controller 252 and/or the proprietary controller 256 in FIG. 2) in a wireless device using a Host Controller Interface (HCI) 320. The HCI 320 may also be used to interface the Controller block 306 with the Host block 304. Interfacing the Controller block 306 and the Host block 304 may enable a wide range of Host blocks to interface with the Controller block 306.

The Application block 302 may include a higher-level Application Layer (App) 308, and the modified BLE protocol stack 300 may run under the App 308. The Host block 304 may include a Generic Access Profile (GAP) 310, a Generic Attribute Protocol (GATT) 312, a Security Manager (SM) 314, an Attribute Protocol (ATT) 316, and a Logical Link Control and Adaptation Protocol (L2CAP) 318, each of which are described in further detail below. The Controller block 306 may include a LL 322, a QLL 324, a Direct Test Mode (DTM) 326, and a Physical Layer (PHY) 328, each of which are described in further detail below.

To support new applications (e.g., IoT applications, audio applications, etc.), the PHY 328 of the present disclosure may support an increased range and data rate as compared to the PHY in a traditional BLE protocol stack. The PHY 328 may define the mechanism for transmitting a bit stream over a physical link that connects BLE devices and/or peer proprietary devices. The bit stream may be grouped into code words or symbols, and converted to a data PDU and/or control PDU that is transmitted over a transmission medium. The PHY 328 may provide an electrical, mechanical, and procedural interface to the transmission medium. The shapes and properties of the electrical connectors, the frequency band used for transmission, the modulation scheme, and similar low-level parameters may be specified by the PHY 328.

The DTM 326 may allow testing of the PHY 328 by transmitting and receiving sequences of test packets. DTM 326 may be used in compliance and production-line testing without the need of going through the complete modified BLE protocol stack 300. In other words, the DTM 326 may skip the Host block 304 and communicate directly with the short-range communications controller and/or the proprietary controller of the radio (e.g., see short-range communications controller 252, the proprietary controller 256, and radio 230 in FIG. 2) in an isolated manner.

The LL 322 may be responsible for low level communication over the PHY 328. The LL 322 may manage the sequence and timing of transmitted and received LL data PDUs, and using a LL protocol, communicate with other devices regarding connection parameters and data flow control. The LL 322 may also provide gate keeping functionality to limit exposure and data exchange with other devices. If filtering is configured, the LL 322 may maintain a list of allowed devices and may ignore all requests for data PDU and/or control PDU exchange from devices not on the list. The LL 322 may use the HCI 320 to communicate with upper layers of the modified BLE protocol stack 300. In certain aspects, the LL 322 may be used to generate a LL data PDU and/or an empty packet that may be transmitted using a LL communication link established with another BLE device and/or peer proprietary device.

The QLL 324 is a proprietary protocol that exists alongside the LL 322. The QLL 324 may be used to discover peer proprietary devices, and establish a secure QLL communication link therewith. For example, the QLL 324 may be used to establish a QLL communication link between proprietary controllers in two wireless Qualcomm® devices.

The proprietary controllers in peer proprietary devices may communicate with each other using allocated channels, a control protocol, attributes, and procedures.

Proprietary controllers may either establish a QLL communication link after a standard connection at the LL 322 has been established or over an advertising bearer. Once a QLL communication link has been established at the QLL 324, the proprietary controllers of two peer proprietary devices may be able to communicate with each other using a set of dedicated channels.

Each channel exists at the point of link establishment, and a QLL establishment PDU may be sent to a peer device at any time on any channel. One channel may be used to perform service discovery. Additional channels may also be available depending on the services exposed by the peer proprietary device. Each QLL establishment PDU sent may include a channel number, a direction bit, and an opcode. The direction bit may determine if the QLL establishment PDU is an original request message or a response message. The opcode may be used to determine the operation being requested, or responded to. In certain configurations, the opcode may be followed by zero or more octets of parameters.

Each service available at a proprietary controller may be associated with a particular channel number. A proprietary controller may include up to or more than, e.g., 127 different services. The services may include, e.g., firmware updates, licensing additional codes, and/or adding additional firmware components on peer devices just to name a few. In certain aspects, services may be available at a proprietary controller but not currently active. For example, a service may include the ability to manage a PHY connection with a peer proprietary device but no PHY connections are currently active. Hence, the management of a PHY connection is not currently active.

The opcodes may be defined as one of three different types. The first type of opcode may be common opcodes that every channel supports. The common opcodes may be used by a proprietary controller to access attributes of a peer proprietary controller. The proprietary controller that receives a QLL establishment PDU with an opcode that is unrecognized may reject the QLL establishment PDU (e.g., the proprietary controller with not response with a QLL establishment PDU). The second type of opcode may be unassigned opcodes that no channel may use, and would therefore be rejected if included in a QLL establishment PDU that is received by a proprietary controller. The third type of opcode may be channel specific opcodes that are associated with procedures that are specific to a particular channel. Channel specific opcodes may be reused by multiple channels. Each channel-specific opcode values defined by a channel may be in a separate number space than other channels and may overlap with opcodes values assigned by other channels.

Common opcodes may allow access to a number of attributes that expose simple readable and writable values that would otherwise require custom opcodes for each channel. Common opcodes may be used for reading an attribute, and for writing an attribute. Common opcodes that may be used to read and/or write an attribute may cause a response from a peer proprietary controller. In certain configurations, one request may be outstanding at any time per channel. Certain common opcodes may be used to determine the current status of a peer service, which may enable a peer proprietary device to determine if a requested service is exposed but not available, e.g., because the appropriate application software has not yet been loaded at the requesting peer proprietary device.

Attributes may be defined as one of three different types. Common attributes may exist for every service, unassigned attributes may not defined, and channel specific attributes may enable a peer proprietary device to associate a specific attribute with a specific channel. Attribute identifiers for channel specific attributes may be reused by multiple channels.

Procedures associated with the QLL 324 may be defined for both master devices and slave devices such that behavior on both sides may be documented. Each procedure may define how the master device will initiate the procedure, how the slave device responds, and when the procedure is completed. If the slave device fails to respond as expected, a global procedure response timeout may be used, at which point communication between the peer proprietary devices may be terminated.

The purpose of the QLL 324 is to establish secure channels between two proprietary controllers with reduced host level support. By establishing secure channels between two proprietary controllers, communications via a QLL communication link may be independent of the hardware, firmware, host operating system, host software stacks and host application support. A secure QLL communication link between two proprietary controllers may provide services such as firmware updates, licensing additional codes, or add additional firmware components on peer devices with minimal host software support by a peer proprietary device just to name a few. The QLL 324 may support providing secure channels between to host level components bypassing the normal BT protocols.

The Root of Trust (RoT) 330 may provide a set functions that may be trusted by a proprietary device's operating system (OS). The RoT 330 may control a trusted computing platform cryptographic processor at a proprietary device.

QRoot key 332 may include a shared key that may be used for communication with other proprietary devices. The QRoot key 332 may be used to indicates that a device is a QLL supporting device.

The original equipment manufacturer (OEM)/App root keys 334 may include a shared key that may be used for communication with other devices that support a specific OEM or a specific App. In certain configurations, after a device is sold different functionality related to the QLL, a specific OEM, and/or a specific App may be enabled by “turning on” specific keys maintained at the QRoot key 332 and/or the OEM/App root keys 334.

The QLL security 336 may include a set of security algorithms that may be used to enable authentication of other proprietary devices based on the QRoot key 332 and/or the OEM/App keys 334.

The QLL Establishment Protocol 338 may establish a QLL communication link with a peer proprietary device using a connection establishment bearer or an advertising establishment bearer.

The QLL Control Protocol 340 may serve as a QLL channel multiplexer for the QLL communication link. The QLL Control Protocol 340 may also define the QLL control PDUs and QLL control procedures used to manage the QLL logical channels. The QLL Control Protocol 340 may define a standard set of QLL control PDUs available to all channels, and permit each QLL channel to define channel-specific QLL Control PDUs and procedures.

The QLL control PDU may include a channel number that identifies the channel for which the QLL control PDU is directed. By including a channel number in the QLL control PDU, a logical channel used to communicate with a component associated with the channel on a proprietary controller of a peer proprietary device may be created. The logical channel is referred to as a QLL channel. Each QLL control PDU may be processed in the context of the QLL channel on which the QLL control PDU is sent. Examples of QLL Channel Numbers are seen below in Table 1.

TABLE 1
QLL Channel Numbers

| Channel Number | Channel Name |
|---|---|
| 0 | Link Control |
| 1 | Security Management |
| 2 | Link Layer |
| 3 | Coexistence |
| 64 | Host Service Discovery |

The initiator role and the responder role may be defined with respect to the QLL control procedures. For example, a proprietary controller sending a procedure request may be considered an initiator, and a proprietary controller sending a procedure response may be considered a responder.

A QLL control procedure, except for the termination procedure, may be initiated with another proprietary controller if no other QLL control procedure has been initiated. However, a new QLL control procedure may be initiated by a local proprietary controller after a peer proprietary controller has initiated a QLL control procedure, but before a QLL control PDU is received by the local proprietary controller. The termination procedure may occur at any time, even while another QLL control procedure is underway.

QLL control procedures may not be performed until both proprietary controllers are in a QLL connected state (e.g., the QLL communication link is established). All QLL control PDUs within a QLL control procedure may be sent during one or more QLL connection events. In certain configurations, QLL control procedures may not need to be performed in a particular order. In certain other configurations, QLL control procedures may not be dependent on any other QLL control procedure.

All QLL communication links may support a QLL control channel (CC) 342 (e.g., channel 1), and the QLL CC 342 may be used to perform QLL control procedures. Examples of QLL control procedures that may be performed on the QLL CC 342 include procedures for performing QLL service discovery to identify a peer proprietary controller, determining other QLL channels, determining QLL features supported between two proprietary controllers, and/or performing QLL security management procedures. Performing QLL control procedures may include exchanging QLL control PDUs.

The QLL CC 342 may support one or more channel information attributes, and a feature bit field in a QLL control PDU may be set to indicate which channels are supported by a particular proprietary controller.

To perform the service discovery procedure, an initiator may perform a channel information discovery procedure on the QLL CC 342. After receiving the channel information from a responder via the QLL CC 342, the initiator may perform the channel information discovery procedure for all channels that are indicated as supported in the feature bits of a QLL control PDU until all channel information is gathered by the initiator for all supported channels.

In certain scenarios, an encryption key used to encrypt QLL control PDUs may be challenged by an initiator (e.g., to ensure that a responder device is able to verify the encryption key). In certain other scenarios, the key may need to be updated. To challenge an encryption key, an initiator may send a QLL_KEY_CHALLENGE_REQ PDU to the responder to ensure the responder is able to verify the encryption key. The responder may send a QLL_KEY_RSP PDU to the initiator when the QLL_KEY_CHALLENGE_REQ PDU is received. The initiator may be able to determine if the responder was able to verify the challenge based on the encryption key and/or other information related to the encryption key included in the QLL_KEY_RSP PDU. QLL security management procedures may include the challenge of an encryption key. Examples of security channel-specific opcodes associated with the QLL security management procedures are seen below in Table 2.

TABLE 2
QLL Control Channel Opcodes

| Opcode | QLL Security Management PDU |
|---|---|
| 0xA0 | QLL_KEY_CHALLENGE_REQ |
| 0xA1 | QLL_KEY_RSP |
| 0xA2 | QLL_SESSION_KEY_UPDATE_IND |

The format of a control data (CtrData) field included in the QLL_KEY_CHALLENGE_REQ PDU is shown below in Table 3.

TABLE 3
CtrData field of the QLL_KEY_CHALLENGE PDU
CtrData

| | |
|---|---|
| Key ID | Challenge |
| (1 octet) | (16 octets) |

The Key ID field seen above in Table 3 may include a bit value (e.g., an 8-bit value) that may be used by the responder to identify the key being challenged. The Challenge field seen above in Table 3 may include a cryptographic random number used to challenge the responder.

The format of a CtrData field included in the QLL_KEY_RSP PDU that is transmitted by the responder is shown below in Table 4.

TABLE 4
CtrData field of the QLL_KEY_RSP PDU
CtrData
Response
(1 octet)

The Response field shown above in Table 4 may be a function of the Challenge value and the key that was challenged in the QLL_KEY_CHALLENGE_REQ PDU received by the responder.

The format of a CtrData field included in the QLL_KEY_UPDATE_IND PDU that is transmitted by the initiator is shown below in Table 5.

TABLE 5
CtrData field of the QLL_KEY_UPDATE_IND PDU
CtrData

| | |
|---|---|
| Key ID | Instant |
| (1 octet) | (2 octets) |

The Key ID field seen above in Table 5 may be a predetermined bit value (e.g., an 8-bit value) that may be used to identify the key that was challenged. The Instant field seen above in Table 5 may be used to indicate the QLL connection event in which the new session key may be used.

The QLL CC 342 may also be used to terminate a QLL communication link that is established with a peer proprietary controller. In certain configurations, the termination procedure may begin and end with an initiator sending a QLL_TERMINATE_IND PDU to the responder. The proprietary controller initiating the termination procedure set the reason code in the Reason field of the QLL_TERMINATE_IND PDU to indicate the reason for the termination. Upon sending the QLL_TERMINATE_IND PDU the initiator may deallocate all resources previously allocated for the QLL communication link, and return to the QLL standby state. In certain configurations, the termination procedure may be initiated at any time, even while another QLL control procedure has not completed.

Certain control channel specific opcodes may be used to indicate that the QLL communication link is terminated. One example of a channel-specific opcode associated with the QLL CC 342 is seen below in Table 6.

TABLE 6
QLL Control Channel Opcode

| Opcode | QLL Control PDU |
|---|---|
| 0xA0 | QLL_LINK_TERMINATE_IND |

The reason field (e.g., CtrData field) in the QLL_LINK_TERMINATE_IND PDU may be used to indicate the reason for the termination procedure. An example format of the reason field is shown blow in Table 7.

TABLE 7
CtrData field of the QLL_TERMINATE_IND PDU
CtrData
Reason
(1 octet)

The Controller Channels 344 (e.g., channel 2 . . . channel n) may be used to enable different functionality in the controller (e.g., short-range communication controller 252, Controller 306, etc.) to be multiplexed between two or more proprietary devices. For example, the Controller Channels 344 may enable power control updates or codec updates to be performed by an exchange of information between two or more proprietary devices using the Controller Channels 344.

The Host Channels 346 (e.g., channel n+1, channel n+2 . . . channel n+m) may be used to enable different functionality in the Host 304 to be multiplexed between two or more proprietary devices. For example, the Host Channels 344 may enable updates to host protocols (e.g., such as music channel control) to be performed by an exchange of information between two or more proprietary devices using the Host Channels 346.

The QLL HCI Extensions 348 may be used to enable communication between the Host 304 and a controller of another proprietary device.

The L2CAP 318 may encapsulate multiple protocols from the upper layers into a LL data PDU and/or a QLL establishment PDU (and vice versa). The L2CAP 318 may also break large LL data PDUs, a QLL establishment PDUs, and/or QLL control PDUs from the upper layers into segments that fit into a maximum payload size (e.g., 27 bytes) on the transmit side. Similarly, the L2CAP 318 may receive multiple LL data PDUs, a QLL establishment PDUs, and/or QLL control PDUs that have been segmented, and the L2CAP 318 may combine the segments into a single LL data PDUs, a QLL establishment PDUs, and/or QLL control PDUs that may be sent to the upper layers.

The ATT 316 may be a client/server protocol based on attributes associated with a BLE device configured for a particular purpose (e.g., monitoring heart rate, temperature, broadcasting advertisements, etc.). The attributes may be discovered, read, and written by peer proprietary devices. The set of operations which are executed over ATT 316 may include, but are not limited to, error handling, server configuration, find information, read operations, write operations, queued writes, etc. The ATT 316 may form the basis of data exchange between BLE devices and/or peer proprietary devices.

The SM 314 may be responsible for device pairing and key distribution. A security manager protocol implemented by the SM 314 may define how communications with the SM of a peer proprietary device and/or counterpart BLE device are performed. The SM 314 may provide additional cryptographic functions that may be used by other components of the modified BLE protocol stack 300. The architecture of the SM 314 used in BLE may be designed to reduce recourse requirements for peripheral devices by shifting work to a central device. BLE uses a pairing mechanism for key distribution. The SM 314 provides a mechanism to encrypt the data and also to provide data authentication.

The GATT 312 describes a service framework using the attribute protocol for discovering services, and for reading and writing characteristic values on a peer proprietary device and/or counterpart BLE device. The GATT 312 interfaces with the App 308 through the App's profiles. The App 308 profile defines the collection of attributes and permission(s) needed for the attributes to be used in BLE communications. One potential advantage of BT technology is device interoperability. Assuring interoperability, using a standardized wireless protocol to transfer bytes of information may be inadequate, and hence, sharing data representation levels may be needed. In other words, both devices may send or receive data in the same format using the same data interpretation based on intended device functionality. The profile is a bridge between the modified BLE protocol stack and the application and functionality of the BLE device (e.g., at least from a wireless connection point of view).

The GAP 310 provides an interface for the App 308 to initiate, establish, and manage connection with other BLE devices and/or peer proprietary devices.

BLE was developed and adopted in various applications in which an infrequent transfer of data occurs. BLE exploits the infrequent transfer of data by using a low duty cycle operation, and switching at least one of the central device and/or peripheral device(s) to a sleep mode in between data transmissions. A BLE communications link between two devices may established using, e.g., hardware, firmware, host operating system, host software stacks, and/or host application support. Example applications that use BLE include battery-operated sensors and actuators in various medical, industrial, consumer, and fitness applications that connect to devices such as BLE enabled smart phones, tablets, and laptops. While traditional BLE offers certain advantages, there exists a need for further improvements in BLE technology.

For example, establishing a QLL communication link between two proprietary devices that is independent of the hardware, firmware, host operating system, host software stacks, and/or host application support may be desirable. By establishing a QLL communication link that is independent of the hardware, firmware, host operating system, host software stacks, and/or host application support, services such as firmware updates, licensing additional codes, and/or adding additional firmware components on peer devices with minimal peer host software support may be supported.

Thus, there exists a need for a technique to establish a QLL communication link between two proprietary devices that is independent of the hardware, firmware, host operating system, host software stacks, and/or host application support, and to perform QLL control procedures associated with the QLL communication link.

The present disclosure provides a QLL protocol that exists alongside of the LL in the BLE protocol stack. The QLL protocol may be used to discover other proprietary devices. The QLL protocol may also be used to establish a secure QLL communication link with another proprietary device that is independent of the hardware, firmware, host operating system, host software stacks, and/or host application support in order to support services such as firmware updates, licensing additional codes, and/or adding additional firmware components. In addition, the QLL protocol may be used to perform QLL control procedures associated with the QLL communication link.

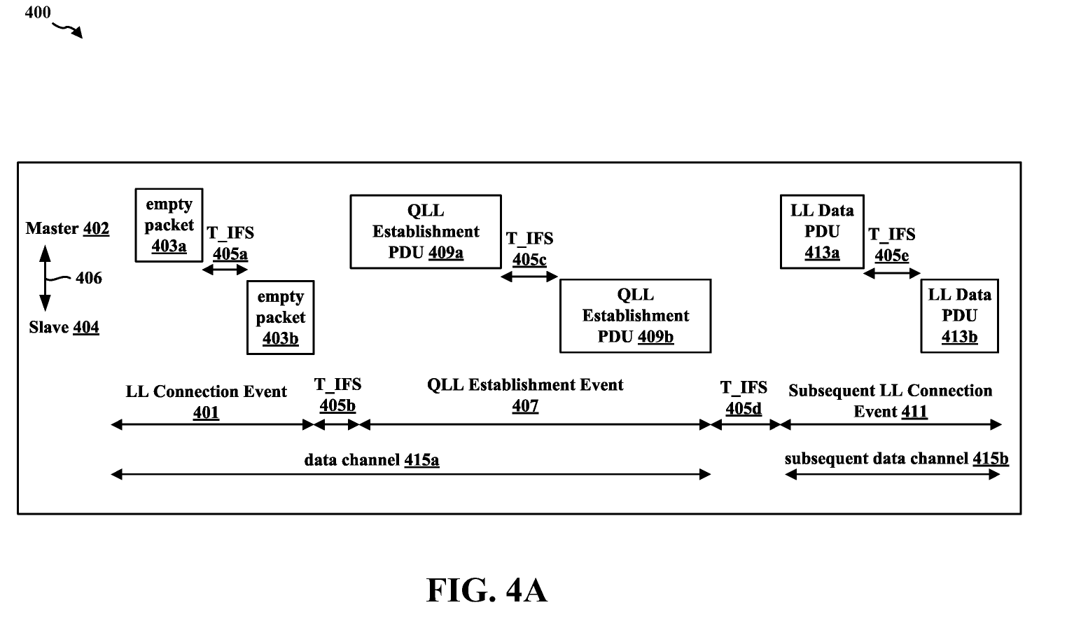

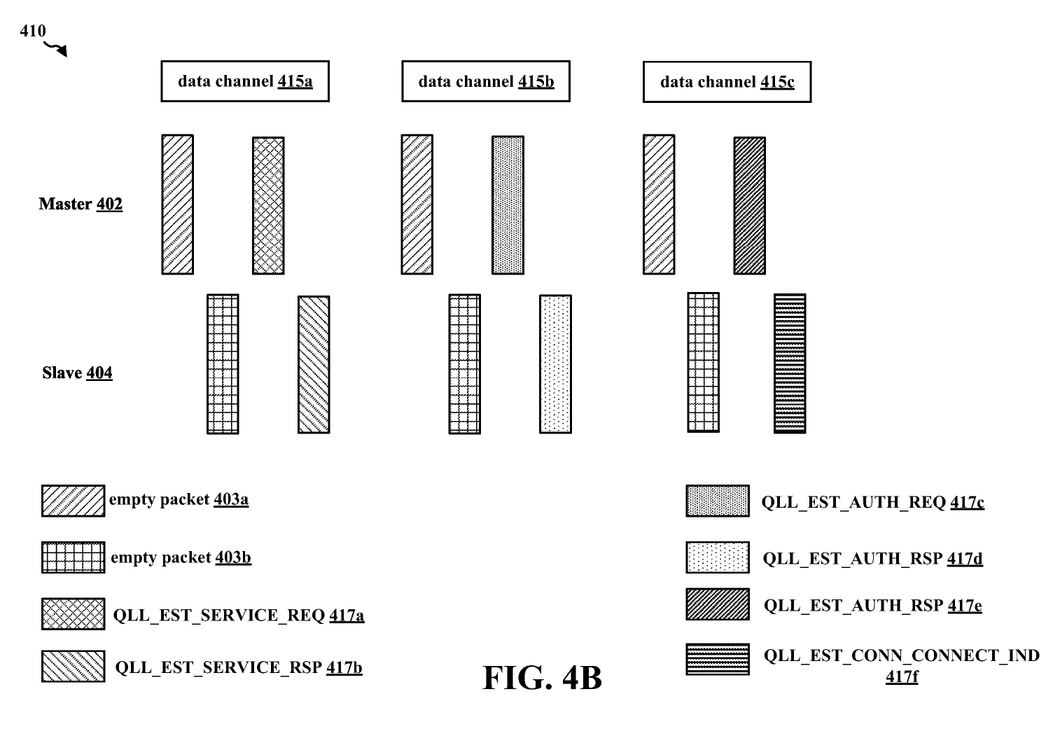

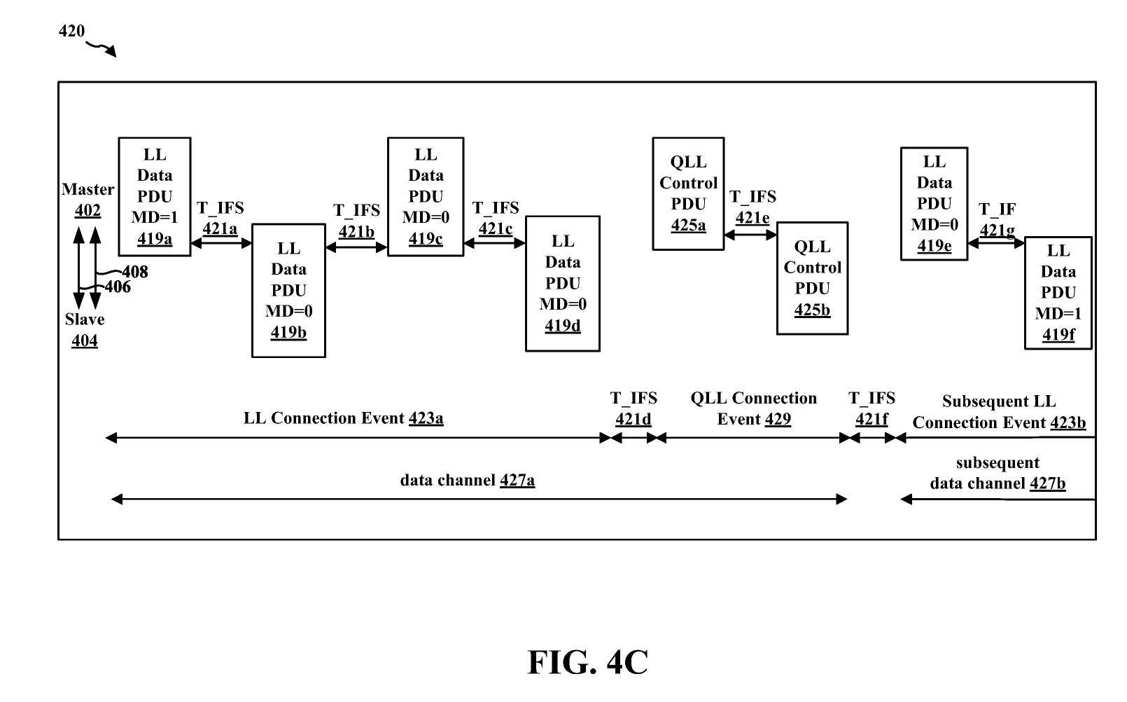

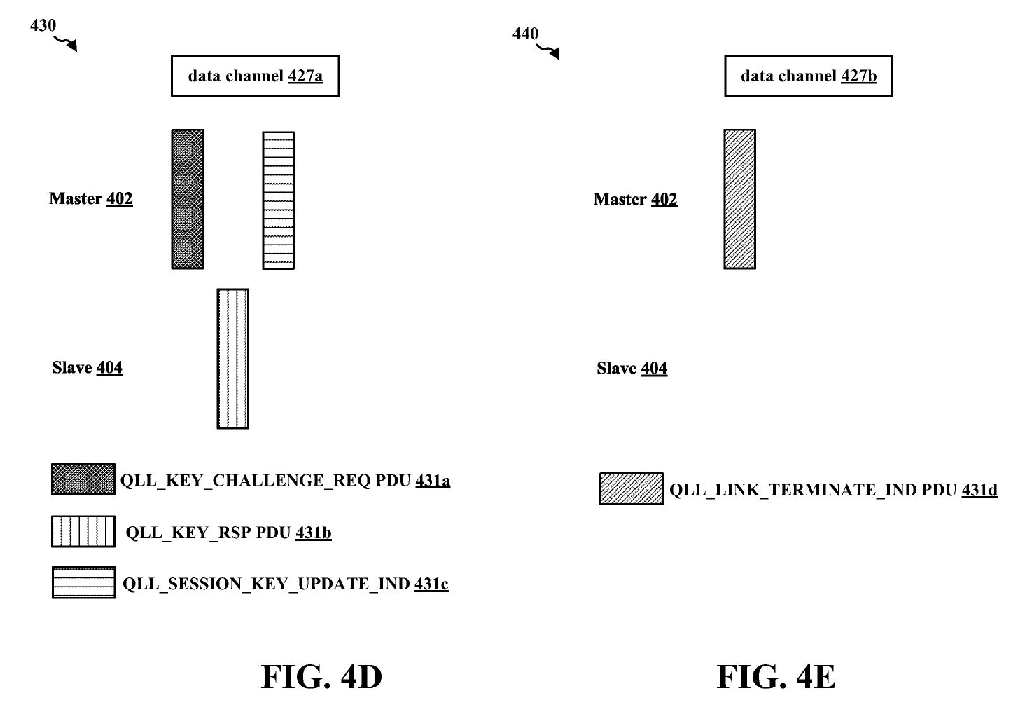

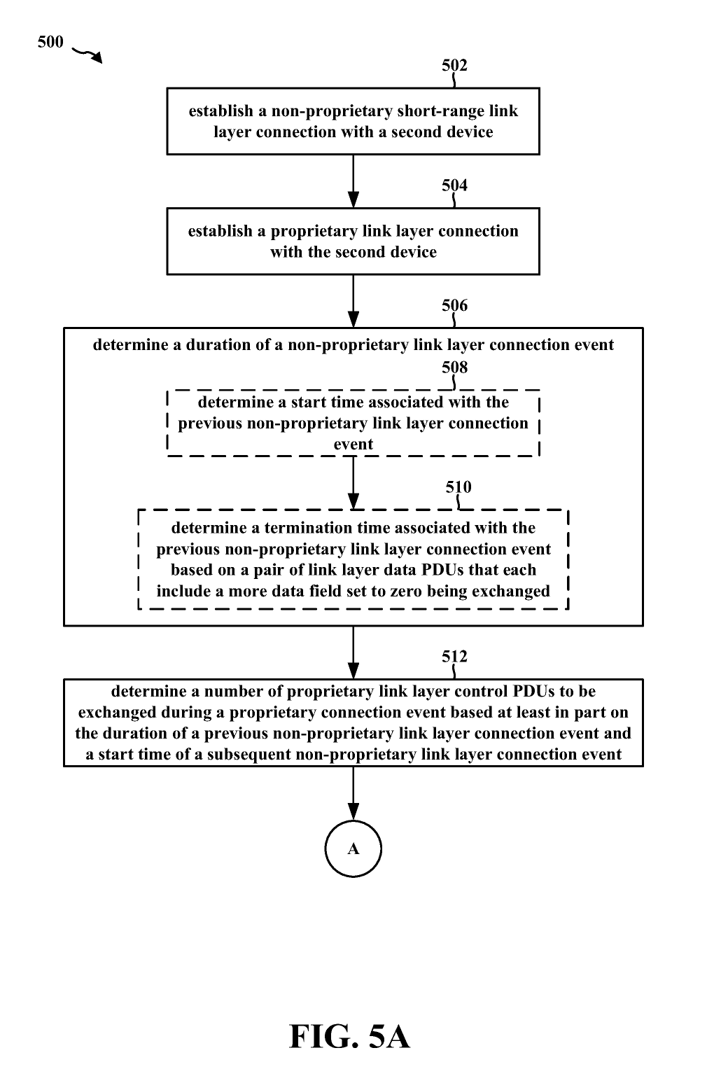

FIG. 4A illustrates a data flow 400 that may be used to establish a QLL communication link in accordance with certain aspects of the disclosure. The QLL communication link may be between a master device 402 and a slave device 404. In certain aspects, the master device 402 and the slave device 404 may be BLE enabled devices. In certain other aspects, the master device 402 and the slave device 404 may be peer proprietary devices associated with the same company. The master device 402 may correspond to, e.g., central device 102, peripheral device 104, 106, 108, 110, 112, 114, wireless device 200, the apparatus 602/602′, the second device 650. The slave device 404 may correspond to, e.g., central device 102, peripheral device 104, 106, 108, 110, 112, 114, wireless device 200, the second device 650, the apparatus 602/602′.

Referring to FIG. 4A, the master device 402 and the slave device 404 may establish a LL connection 406. The master device 402 may transmit an empty packet 403a to the slave device 404 during a LL connection event 401 when the master device 402 does not have a LL data PDU to transmit to the slave device 404. The slave device 404 may respond with an empty packet 403b that is transmitted at a predetermined time (e.g., T_IFS 405a) after the transmission of the empty packet 403a. The slave device 404 may respond with the empty packet 403a when the slave device 404 does not have a LL data PDU to transmit to the master device 402.

When the LL connection 406 is established, the master device 402 and the slave device 404 may initially be in a default QLL standby state. The master device 402 and the slave device 404 may not send or receive QLL PDUs in the QLL standby state. The master device 402 and the slave device 404 may leave the QLL standby state to enter the QLL establishing state when a LL connection 406 is established between the master device 402 and the slave device 404. The master device 402 may enter the QLL establishing state when the proprietary controller at the master device 402 wants to establish a QLL link with the proprietary controller of the slave device 404.

A QLL establishment event 407 may begin a predetermined time (e.g., T_IFS 405b) after the end of the LL connection event 401. The master device 402 may transmit a QLL establishment PDU 409a to the slave device 404. The slave device 404 may respond with a QLL establishment PDU 409b that is sent at a predetermined time (e.g., T_IFS 405c) after the transmission of the QLL establishment PDU 409a.

The QLL establishment event 407 may use the same data channel 415a that is used during the LL connection event 401. In certain aspects, more than one QLL establishment event may be needed to establish the QLL communication link. In other words, a predetermined series of QLL establishment PDUs may be exchanged before the QLL communication link is established, and one or more of the QLL establishment PDUs may be exchanged during different QLL establishment events. In certain configurations, QLL establishment events may occur whether or not any QLL establishment PDUs are transmitted.

The QLL establishment event 407 may end when the last QLL establishment PDU 409b is sent or after a predetermined time period. A subsequent LL connection event 411 may begin at a predetermined time (e.g., T_IFS 405d) after the end of the QLL establishment event 407. The subsequent LL connection event 411 may use a subsequent data channel 415b. In certain configurations, the subsequent data channel 415b may be a different data channel than data channel 415a. In certain other configurations, the subsequent data channel 415b may be the same as data channel 415a.

As illustrated in FIG. 4A, the master device 402 may transmit a LL data PDU 413a to the slave device 404 (e.g., when the master device 402 has a LL data PDU 413a to transmit to the slave device 404) during a LL connection event (e.g., the subsequent LL connection event 411).

The slave device 404 may respond by sending a LL data PDU 413b at a predetermined time (e.g., T_IFS 405e) after the transmission of the LL data PDU 413a when the slave device 404 has a LL data PDU 413b to send to the master device 402. Because at least one LL data PDU 413a, 413b is transmitted during the subsequent LL connection event 411, a subsequent QLL establishment PDU (not shown in FIG. 4A) that occurs in the subsequent data channel 415b may not be transmitted T_IFS after the end of the subsequent LL connection event 411. Instead, the exchange of subsequent QLL establishment PDUs may be delayed until after another set of empty packets are transmitted in a LL connection event.

QLL establishment timeout may occur when a predetermined number of QLL establishment events have occurred without receiving a proper response to a QLL establishment protocol procedure. For example, QLL establishment PDUs may be received in the proper sequence prior to QLL establishment timeout or the establishment is considered failed, and the QLL establishment procedure may be aborted. The QLL establishment timeout may be reset to a count of zero after a proper QLL establishment PDU in the sequence is received. The QLL establishment protocol may include the exchange of a particular sequence of QLL establishment PDUs. Additional details associated with the QLL establishment protocol and the particular sequence of QLL establishment PDUs are discussed below with respect to FIG. 4B.

FIG. 4B illustrates a QLL establishment protocol 410 used to establish a QLL communication link by exchanging a particular sequence of QLL establishment PDUs in accordance with certain aspects of the disclosure. The QLL establishment protocol 410 may be performed by the master device 402 and the slave device 404 discussed above with reference to FIG. 4A. In certain configurations, the QLL establishment protocol 410 may be performed after a LL connection (e.g., a connection establishment bearer) is established between the master device 402 and the slave device 404.

The QLL establishment protocol 410 may include the exchange of a particular sequence of QLL establishment PDUs. For example, a QLL establishment PDU may be received in the proper sequence prior to the QLL establishment timeout or the establishment may be considered failed, and thus, aborted. Once a QLL establishment PDU is received in the proper sequence by either the master device 402 or the slave device 404, the establishment timeout counter at the master device 402 and/or the slave device 404 may be reset. QLL establishment PDUs received out-of-sequence may be ignored. When a QLL establishment PDU is received out-of-sequence, the receiving proprietary controller may not reset the establishment timeout counter. If the QLL establishment procedure is aborted, the proprietary controllers may return to the QLL standby state discussed above with reference to FIG. 4A.

The proper sequence of QLL establishment PDUs in the QLL establishment protocol 410 may include the following: 1) QLL_EST_SERVICE_REQ 417a sent by the master device 402, 2) QLL_EST_SERVICE_RSP 417b sent by the slave device 404, 3) QLL_EST_AUTH_REQ 417c sent by the master device 402, 4) a first QLL_EST_AUTH_RSP 417d sent by the slave device 404, 5) a second QLL_EST_AUTH_RSP 417e sent by the master device 402, and 6) QLL_EST_CONN_CONNECT_IND 417f sent by the slave device 404.

In certain configurations, each of the QLL establishment PDUs 417a, 417b, 417c, 417d, 417e, 417f may include a challenge that is verified by the receiving proprietary device before a response is transmitted. When a challenge cannot be verified, the subsequent QLL establishment PDU may not be transmitted and the QLL establishment protocol 410 may be aborted. If the QLL establishment protocol is aborted, the proprietary device may return to the QLL standby state.

Referring to FIG. 4B, a first LL connection event and a first QLL establishment event may occur using a first data channel 415a. During the first LL connection event on the first data channel 415a, the master device 402 and the slave device 404 may exchange empty packets 403a, 403b. During the first QLL establishment event on the first data channel 415a, the master device 402 may transmit the QLL_EST_SERVICE_REQ 417a and the slave device 404 may transmit the QLL_EST_SERVICE_RSP 417b. For example, when the slave device 404 receives the QLL_EST_SERVICE_REQ 417a, the slave device 404 may respond in the same QLL establishment event or the next QLL establishment event with a QLL_EST_SERVICE_RSP 417b when a challenge included in the QLL_EST_SERVICE_REQ 417a can be verified by the slave device 404. The QLL_EST_SERVICE_RSP 417b may include a challenge that the master device 402 may verify before sending the next QLL establishment PDU in the QLL establishment protocol 410.

In certain implementations, a second LL connection event and a second QLL establishment event may occur on a second data channel 415b. During the second LL connection event on the second data channel 415b, the master device 402 and the slave device 404 may exchange empty packets 403a, 403b. During the second QLL establishment event on the second data channel 415b, the master device 402 may transmit the QLL_EST_AUTH_REQ 417c and the slave device 404 may transmit the QLL_EST_AUTH_RSP 417d.

In certain configurations, the QLL_EST_AUTH_REQ 417c may include a challenge that the slave device 404 may verify before transmitting the QLL_EST_AUTH_RSP 417d. In certain other configurations, the first QLL_EST_AUTH_RSP 417d may include a challenge that the master device 402 may verify before sending the next QLL establishment PDU in the QLL establishment protocol 410.

In certain other implementations, a third LL connection event and a third QLL establishment event may occur on a third data channel 415c. During the third LL connection event on the third data channel 415c, the master device 402 and the slave device 404 may exchange empty packets 403a, 403b. During the third QLL establishment event on the third data channel 415c, the master device 402 may transmit the QLL_EST_AUTH_RSP 417e and the slave device 404 may transmit the QLL_EST_CONN_CONNECT_IND 417f.

In certain configurations, the QLL_EST_AUTH_RSP 417e may include a challenge that the slave device 404 may verify before transmitting the QLL_EST_CONN_CONNECT_IND 417f. In certain other configurations, the QLL_EST_CONN_CONNECT_IND 417f may include a challenge that the master device 402 may verify before the QLL communication link is established between the master device 402 and the slave device 404. Once the QLL communication link is established, the master device 402 and the slave device 404 may enter a QLL connected state. Once in the QLL connected state, QLL data PDUs and/or QLL control PDUs may be exchanged.

FIG. 4C illustrates a data flow 420 that may be used to perform QLL control procedures in accordance with certain aspects of the disclosure. The data flow 420 may occur after a QLL communication link is established as discussed above with reference to FIGS. 4A and 4B. The QLL control procedure may occur between a master device 402 and a slave device 404. In certain aspects, the master device 402 and the slave device 404 may be BLE enabled devices. In certain other aspects, the master device 402 and the slave device 404 may be peer proprietary devices associated with the same company. The master device 402 may correspond to, e.g., central device 102, peripheral device 104, 106, 108, 110, 112, 114, wireless device 200, the apparatus 602/602′, the second device 650, an initiator, a responder. The slave device 404 may correspond to, e.g., central device 102, peripheral device 104, 106, 108, 110, 112, 114, wireless device 200, the apparatus 602/602′, the second device 650, an initiator, a responder.

Referring to FIG. 4C, the master device 402 and the slave device 404 may establish a LL connection 406 and QLL communication link 408. Various LL data PDUs 419a, 419b, 419c, 419d, 419e, 419f may be exchanged by the master device 402 and the slave device 404 during one or more LL connection events 423a, 423b. Various QLL control PDUs 425a, 425b may be exchanged by the master device 402 and the slave device 404 during a QLL connection event 427. A first LL connection event 423a and a QLL connection event 429 may occur on a first data channel 427a. A subsequent LL connection event 423b may occur on a subsequent data channel 427b. Depending on the length of the subsequent LL connection event 423b, a subsequent QLL connection event (not shown in FIG. 4C) may also occur on the subsequent data channel 427b.

During the first LL connection event 427a, the master device 402 may transmit a LL data PDU 419a to the slave device 404. The more data (MD) field in the LL data PDU 419a may be set to ‘1’ indicating that the master device 402 has at least one additional LL data PDU to send to the slave device 404 during the LL connection event 419. The slave device 404 may transmit a LL data PDU 419b a predetermined time (e.g., T_IFS 421a) after the transmission of the LL data PDU 419a when the slave device 404 has a LL data PDU to send to the master device 402. Otherwise, the slave device 404 may send an empty packet (not illustrated in FIG. 4C) to the master device 402. The MD field of the LL data PDU 419b may be set to ‘0’ if the slave device 404 does not have any additional LL data PDUs to send to the master device 402.

The master device 402 may transmit another LL data PDU 419c a predetermined time (e.g., T_IFS 421b) after the transmission of the LL data PDU 419b. The MD field of the LL data PDU 419c may be set to ‘0’ if the master device 402 does not have any additional LL data PDUs to send to the slave device 404.

After the transmission of the LL data PDU 419b, the slave device 404 may generate an additional LL data PDU 419d to send to the master device 402. The slave device 404 may transmit the LL data PDU 419d a predetermined time (e.g., T_IFS 421c) after the transmission of the LL data PDU 419c. The MD field of the LL data PDU 419d may be set to ‘0’ if the slave device 404 does not have any additional LL data PDUs to send to the master device 402. Once the initiator (e.g., master device 402) and the responder (e.g., slave device 404) exchange consecutive LL data PDUs with the MD field set to ‘0’, the LL connection event 423 may terminate.

The QLL connection event 429 may begin a predetermined time (e.g., T_IFS 421d) after the termination of the LL connection event 423a. The master device 402 and the slave device 404 may exchange as many QLL control PDUs as possible during the QLL connection event 429. The number of QLL control PDUs that are transmitted during a QLL connection event may be determined based at least in part on the duration of the QLL connection event 429.

For example, the master device 402 and/or the slave device 404 may determine a maximum number of QLL control PDUs that may be exchanged during the QLL connection event 429 based at least in part on a duration of the LL connection event 423a and the start of the subsequent LL connection event 423b.

The duration of the LL connection event 423a may be determined based at least in part on a start time of the LL connection event 423a, a termination time of the LL connection event 423a, and/or a number of LL data PDUs 419a, 419b, 419c, 419d transmitted during the LL connection event 423a. The termination time of the LL connection event 423a may be determined when a the master device 402 transmits a LL data PDU 419c with the MD field set to ‘0’, and the slave device 404 responds with a LL data PDU 419d with the MD field set to ‘0’.

Referring to the QLL connection event 429, the master device 402 may transmit a first QLL control PDU 425a to the slave device at the start of the QLL connection event 429 if there is a QLL control PDU to transmit. The slave device 404 may transmit a QLL control PDU 425b to the master device 402 in response to receiving the QLL control PDU 425a. Although two QLL control PDUs are exchanged during the QLL connection event 429, a single QLL control PDU or more than two QLL control PDUs may be exchanged during a QLL connection event without departing from the scope of the present disclosure. For example, if two LL data PDUs are exchanged during the LL connection event 423a (rather than the four), the LL connection event 423a may terminate at an earlier time, which leaves more time for the QLL connection event 429, and hence, more than two QLL control PDUs may be exchanged before the start of the subsequent LL connection event 423b.

In one aspect, the QLL control PDU 425a may include one of a QLL_KEY_CHALLENGE_REQ PDU, a QLL_KEY_RSP PDU, a QLL_SESSION_KEY_UPDATE_IND, or a QLL_LINK_TERMINATE_IND PDU just to name a few. In another aspect, the QLL control PDU 425b may include one of a QLL_KEY_CHALLENGE_REQ PDU, a QLL_KEY_RSP PDU, a QLL_SESSION_KEY_UPDATE_IND, or a QLL_LINK_TERMINATE_IND PDU just to name a few.

A predetermined amount of time (e.g., T_IFS 421f) may be occur between the end of the QLL connection event 429 and the start of the subsequent LL connection event 423b. The subsequent LL connection event 423b may occur on a subsequent data channel 427b. In certain configurations, the subsequent data channel 427b may be the same as the first data channel 427a. In certain other configurations, the subsequent data channel 427b may be different than the first data channel 427a.

During the subsequent LL connection event 423b, the master device 402 may transmit a LL data PDU 419e to the slave device 404. The LL data PDU 419e may include an MD field set to ‘0’ indicating that the master device 402 does not currently have any additional LL data PDUs to send to the slave device 404 during the subsequent LL connection event 423b. The slave device 404 may send a LL data PDU 419f at a predetermined time (e.g., T_IFS 421g) after the transmission of the LL data PDU 419e. The LL data PDU 419f may include an MD field set to ‘1’ indicating that the slave device 404 has at least one additional LL data PDU to send to the master device 402 during the subsequent LL connection event 423b. Depending on the number of additional LL data PDUs exchanged during the subsequent LL connection event 423b, a subsequent QLL connection event may occur on the subsequent data channel a predetermined time (e.g., T_IFS) after the termination of the subsequent LL connection event 423b.

The exchange of QLL control PDUs during one or more QLL connection events as described above with reference to FIG. 4C may be used to perform QLL service discovery to identify a peer proprietary controller, determine other QLL channels, determine QLL features supported between two proprietary controllers, perform QLL security management procedures, and/or terminating a QLL communication link.

FIG. 4D illustrates a QLL key challenge protocol 430 that may be used to verify an encryption key used during data communication via a QLL communication link in accordance with certain aspects of the disclosure. The QLL key challenge protocol 430 may be performed by the master device 402 and the slave device 404 discussed above with reference to FIG. 4C. In certain configurations, the QLL key challenge protocol 430 may be performed during one or more QLL connection events.

As seen in FIG. 4D, the master device 402 (e.g., the initiator) may send a QLL_KEY_CHALLENGE_REQ PDU 431a to the slave device 404 (e.g., the responder) to ensure the slave device 404 is able to verify the encryption key. The slave device 404 may send a QLL_KEY_RSP PDU 431b to the master device 402 when the QLL_KEY_CHALLENGE_REQ PDU 431a is received. The slave device 404 may generate information associated with the encryption key that is included in the QLL_KEY_RSP PDU 431b. The master device 402 may determine if the slave device 404 is able to verify the challenge based on the information included in the QLL_KEY_RSP PDU 431b.

When the master device 402 determines that the slave device 404 was unable to verify the challenge based on the information included in the QLL_KEY_RSP PDU 431b, the master device 402 may generate a new session key that is communicated to the slave device 404 in QLL_SESSION_KEY_UPDATE_IND 431c. The QLL_SESSION_KEY_UPDATE_IND 431c may also indicate the QLL connection event in which the new session key may be used.

FIG. 4E illustrates a QLL termination protocol 440 that may be used to terminate a QLL communication link in accordance with certain aspects of the disclosure. The QLL termination protocol 440 may be performed by the master device 402 and the slave device 404 discussed above with reference to FIG. 4C. In certain configurations, the QLL termination protocol 440 may be performed during one or more QLL connection events.

In certain aspects, the QLL termination protocol 440 may begin and end with either a master device 402 or the slave device 404 sending a QLL_TERMINATE_IND PDU 431d to the other device. In the present example, the master device 402 initiates the QLL termination protocol 44, and may set the reason code in the Reason field of the QLL_TERMINATE_IND PDU 431d to indicate the reason for terminating the QLL communication link. Upon sending the QLL_TERMINATE_IND PDU 431d the master device may deallocate all resources allocated for the QLL communication link and return to the QLL standby state. Once the QLL_TERMINATE_IND PDU 431d is received, the slave device 404 may deallocate all resources previously allocated for the QLL communication link and return to the QLL standby state.

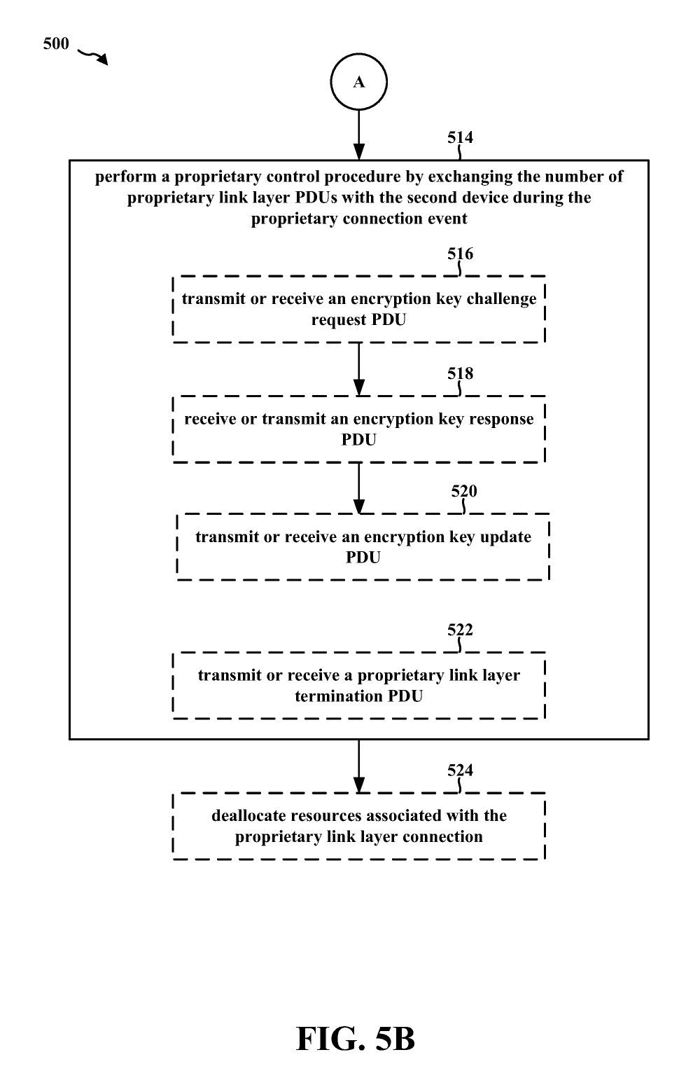

FIGS. 5A and 5B are a flowchart 500 of a method of wireless communication. The method may be performed by a first device (e.g., central device 102, peripheral device 104, 106, 108, 110, 112, 114, wireless device 200, master device 402, slave device 404, the apparatus 602/602′, the second device 650) in communication with a second device (e.g., central device 102, peripheral device 104, 106, 108, 110, 112, 114, wireless device 200, master device 402, slave device 404, the apparatus 602/602′, the second device 650). In FIGS. 5A and 5B, optional operations are indicated with dashed lines.

Referring to FIG. 5A, at 502, the first device may establish a non-proprietary link layer connection with a second device. For example, referring to FIG. 4C, the master device 402 and the slave device 404 may establish a LL connection 406.

At 504, the first device may establish a proprietary link layer connection with the second device. For example, referring to FIG. 4C, the master device 402 and the slave device 404 may establish a QLL communication link 408. Referring to FIG. 4B, the QLL establishment protocol 410 may include the exchange of a particular sequence of QLL establishment PDUs. For example, a QLL establishment PDU may be received in the proper sequence prior to the QLL establishment timeout or the establishment may be considered failed, and the QLL establishment procedure may be aborted. Once a QLL establishment PDU is received in the proper sequence by either the proprietary controller in the master device 402 or the proprietary controller in the slave device 404, the establishment timeout counter (e.g., located at or in communication with the proprietary controller) is reset. QLL establishment PDUs received out-of-sequence may be ignored by a proprietary controller. When a QLL establishment PDU is received out-of-sequence, the receiving proprietary controller may not reset the establishment timeout counter. If the QLL establishment procedure is aborted, the proprietary controllers may return to the QLL standby state discussed above with reference to FIG. 4A. The proper sequence of QLL establishment PDUs in the QLL establishment protocol 410 may include the following: 1) QLL_EST_SERVICE_REQ 417a sent by the master device 402, 2) QLL_EST_SERVICE_RSP 417b sent by the slave device 404, 3) QLL_EST_AUTH_REQ 417c sent by the master device 402, 4) a first QLL_EST_AUTH_RSP 417d sent by the slave device 404, 5) a second QLL_EST_AUTH_RSP 417e sent by the master device 402, and 6) QLL_EST_CONN_CONNECT_IND 417f sent by the slave device 404. In certain configurations, each of the QLL establishment PDUs 417a, 417b, 417c, 417d, 417e, 417f may include a challenge that is verified by the receiving proprietary device before a response is transmitted in the QLL establishment event or a subsequent QLL establishment event. When a challenge cannot be verified, the subsequent QLL establishment PDU may not be transmitted and the QLL establishment protocol 410 may be aborted. If the QLL establishment protocol is aborted, the proprietary device may return to the QLL standby state. Referring to FIG. 4B, a first LL connection event and a first QLL establishment event may occur using a first data channel 415a. During the first LL connection event on the first data channel 415a, the master device 402 and the slave device 404 may exchange empty packets 403a, 403b. During the first QLL establishment event on the first data channel 415a, the master device 402 may transmit the QLL_EST_SERVICE_REQ 417a and the slave device 404 may transmit the QLL_EST_SERVICE_RSP 417b. For example, when the slave device 404 receives the QLL_EST_SERVICE_REQ 417a, the slave device 404 may respond in the same QLL establishment event or the next QLL establishment event with a QLL_EST_SERVICE_RSP 417b on the same data channel when a challenge included in the QLL_EST_SERVICE_REQ 417a can be verified by the slave device 404. The QLL_EST_SERVICE_RSP 417b may include a challenge that the master device 402 may verify before sending the next QLL establishment PDU in the QLL establishment protocol 410. In certain implementations, a second LL connection event and a second QLL establishment event may occur on a second data channel 415b. During the second LL connection event on the second data channel 415b, the master device 402 and the slave device 404 may exchange empty packets 403a, 403b. During the second QLL establishment event on the second data channel 415b, the master device 402 may transmit the QLL_EST_AUTH_REQ 417c and the slave device 404 may transmit the QLL_EST_AUTH_RSP 417d. In certain configurations, the QLL_EST_AUTH_REQ 417c may include a challenge that the slave device 404 may verify before transmitting the QLL_EST_AUTH_RSP 417d. In certain other configurations, the first QLL_EST_AUTH_RSP 417d may include a challenge that the master device 402 may verify before sending the next QLL establishment PDU in the QLL establishment protocol 410. In certain other implementations, a third LL connection event and a third QLL establishment event may occur on a third data channel 415c. During the third LL connection event on the third data channel 415c, the master device 402 and the slave device 404 may exchange empty packets 403a, 403b. During the third QLL establishment event on the third data channel 415c, the master device 402 may transmit the QLL_EST_AUTH_RSP 417e and the slave device 404 may transmit the QLL_EST_CONN_CONNECT_IND 417f. In certain configurations, the QLL_EST_AUTH_RSP 417e may include a challenge that the slave device 404 may verify before transmitting the QLL_EST_CONN_CONNECT_IND 417f In certain other configurations, the QLL_EST_CONN_CONNECT_IND 417f may include a challenge that the master device 402 may verify before the QLL communication link is established between the master device 402 and the slave device 404. Once the QLL communication link is established, the master device 402 and the slave device 404 may enter a QLL connected state and QLL control PDUs may be exchanged.

At 506, the first device may determine a duration of a previous non-proprietary link layer connection event. For example, referring to FIG. 4C, the duration of the LL connection event 423a may be determined by the master device 402 and/or the slave device 404 based at least in part on a start time of the LL connection event 423a, a termination time of the LL connection event 423a, and/or a number of LL data PDUs 419a, 419b, 419c, 419d that are transmitted during the LL connection event 423a. The termination time of the LL connection event 423a may be determined when the master device 402 (e.g., the initiator) transmits a LL data PDU 419c with the MD field set to ‘0’, and the slave device 404 (e.g., the responder) responds with a LL data PDU 419d with the MD field set to ‘0’.

At 508, the first device may determine a duration of the previous non-proprietary link layer connection event by determining a start time associated with the previous non-proprietary link layer connection event. For example, referring to FIG. 4C, the duration of the LL connection event 423a may be determined by the master device 402 and/or the slave device 404 based at least in part on a start time of the LL connection event 423a.

At 510, the first device may determine a duration of the previous non-proprietary link layer connection event by determining a termination time associated with the previous non-proprietary link layer connection event based on a pair of link layer data PDUs that each include a more data field set to zero being exchanged. For example, referring to FIG. 4C, the termination time of the LL connection event 423a may be determined when a the master device 402 (e.g., the initiator) transmits a LL data PDU 419c with the MD field set to ‘0’, and the slave device 404 (e.g., the responder) responds with a LL data PDU 419d with the MD field set to ‘0’.

At 512, the first device may determine a number of proprietary link layer control PDUs to be exchanged during a proprietary connection event based at least in part on the duration of the previous non-proprietary link layer connection event and a start time of a subsequent non-proprietary link layer connection event. For example, referring to FIG. 4C, the master device 402 and the slave device 404 may exchange as many QLL control PDUs as possible during the QLL connection event 429. The number of QLL control PDUs that are transmitted during a QLL connection event may be determined based at least in part on the duration of the QLL connection event 429. For example, the master device 402 and/or the slave device 404 may determine a maximum number of QLL control PDUs that may be exchanged during the QLL connection event 429 based at least in part on a duration of the LL connection event 423a and the start of the subsequent LL connection event 423b.

Referring to FIG. 5B, at 514, the first device may perform a proprietary control procedure by exchanging a number of proprietary link layer PDUs with the second device during the proprietary connection event. In one aspect, the proprietary control procedure may include at least one of identifying a peer proprietary controller in the second device, determining proprietary channels, determining proprietary features supported by both the first device and the second device, performing a proprietary security management procedure, or terminating the proprietary link layer connection. For example, referring to FIG. 4C, the master device 402 may transmit a first QLL control PDU 425a to the slave device at the start of the QLL connection event 429 if there is a QLL control PDU to transmit. The slave device 404 may transmit a QLL control PDU 425b to the master device 402 in response to receiving the QLL control PDU 425a. Although two QLL control PDUs are exchanged during the QLL connection event 429, a single QLL control PDU or more than two QLL control PDUs may be exchanged during a QLL connection event without departing from the scope of the present disclosure. In one aspect, the QLL control PDU 425a may include one of a QLL_KEY_CHALLENGE_REQ PDU, a QLL_KEY_RSP PDU, a QLL_SESSION_KEY_UPDATE_IND, or a QLL_LINK_TERMINATE_IND PDU just to name a few. In another aspect, the QLL control PDU 425b may include one of a QLL_KEY_CHALLENGE_REQ PDU, a QLL_KEY_RSP PDU, a QLL_SESSION_KEY_UPDATE_IND, or a QLL_LINK_TERMINATE_IND PDU just to name a few.

At 516, when the proprietary control procedure is the proprietary security management procedure, the first device may perform the proprietary control procedure by transmitting or receiving an encryption key challenge request PDU. For example, referring to FIG. 4D, the master device 402 (e.g., the initiator) may send a QLL_KEY_CHALLENGE_REQ PDU 431a to the slave device 404 (e.g., the responder) to ensure the slave device 404 is able to verify the encryption key.

At 518, when the proprietary control procedure is the proprietary security management procedure, the first device may perform the proprietary control procedure by receiving or transmitting an encryption key response PDU. For example, referring to FIG. 4D, the slave device 404 may send a QLL_KEY_RSP PDU 431b to the master device 402 when the QLL_KEY_CHALLENGE_REQ PDU 431a is received. The slave device 404 may generate information associated with the encryption key that is included in the QLL_KEY_RSP PDU 431b.

At 520, when the proprietary control procedure is the proprietary security management procedure, the first device may perform the proprietary control procedure by transmitting or receiving an encryption key update PDU. In one aspect, the encryption key update PDU may include information associated with a new encryption key and a subsequent proprietary link layer connection event in which to use the new encryption key. For example, referring to FIG. 4D, the master device 402 may determine if the slave device 404 is able to verify the challenge based on the information included in the QLL_KEY_RSP PDU 431b. When the master device 402 determines that the slave device 404 was unable to verify the challenge based on the information included in the QLL_KEY_RSP PDU 431b, the master device 402 may generate a new session key that is communicated to the slave device 404 in the QLL_SESSION_KEY_UPDATE_IND 431c, which may also indicate the QLL connection event in which the new session key may be used.

At 522, when the proprietary link layer control procedure includes the terminating the proprietary link layer connection, the first device may perform the proprietary control procedure by transmitting or receiving a proprietary link layer termination PDU. For example, referring to FIG. 4E, the QLL termination protocol 440 may begin and end when either a master device 402 or the slave device 404 sends a QLL_TERMINATE_IND PDU 431d to the other device. In the example illustrated in FIG. 4E, the master device 402 initiates the QLL termination protocol 44, and may set the reason code in the Reason field of the QLL_TERMINATE_IND PDU 431d.

At 524, the first device may deallocate resources associated with the proprietary link layer connection. For example, referring to FIG. 4E, upon sending the QLL_TERMINATE_IND PDU 431d the master device may deallocate all resources allocated for the QLL communication link and return to the QLL standby state. Once the QLL_TERMINATE_IND PDU 431d is received, the slave device 404 may deallocate all resources allocated for the QLL communication link and return to the QLL standby state.

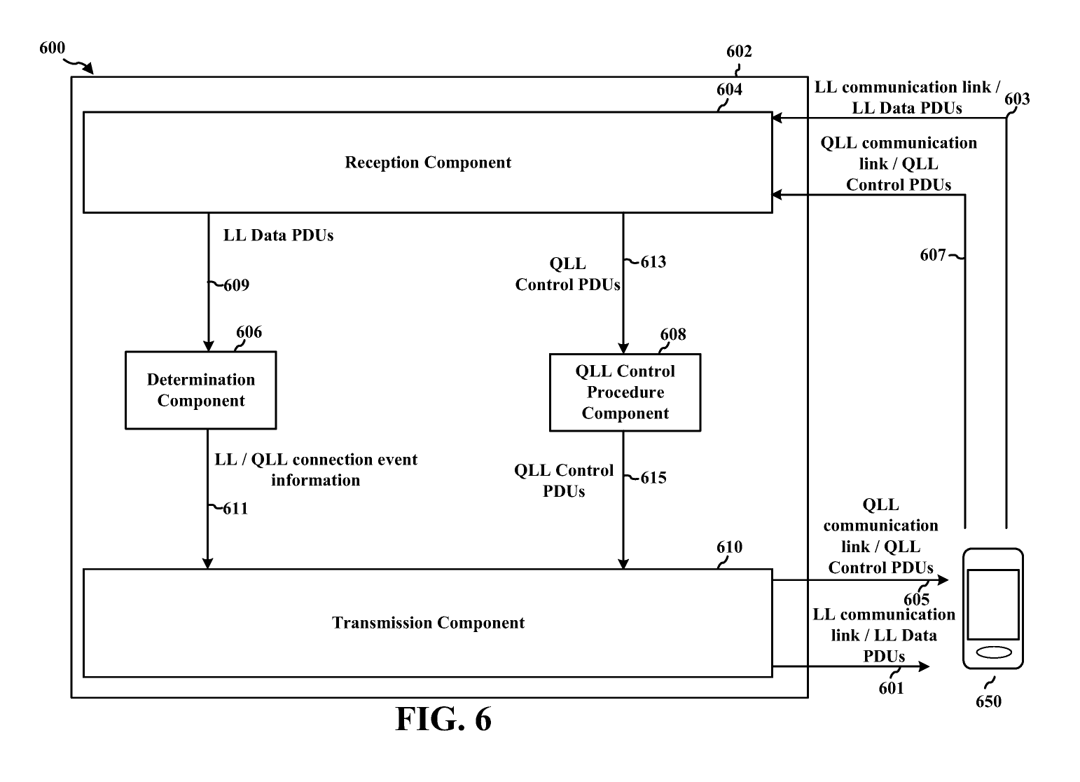

FIG. 6 is a conceptual data flow diagram 600 illustrating the data flow between different means/components in an exemplary apparatus 602. The apparatus may be a first device (e.g., central device 102, peripheral device 104, 106, 108, 110, 112, 114, wireless device 200, master device 402, slave device 404, the apparatus 602′) in communication with a second device 650 (e.g., central device 102, peripheral device 104, 106, 108, 110, 112, 114, wireless device 200, master device 402, slave device 404). The apparatus may include a reception component 604, a determination component 606, a QLL control procedure component 608, and a transmission component 610.

The reception component 604 and/or the transmission component 610 may be configured to establish a non-proprietary link layer connection 601, 603 with the second device 650. The reception component 604 and/or the transmission component 610 may be configured to establish a proprietary link layer connection 605, 607 with the second device 650. The reception component 604 may be configured to receive one or more LL data PDUs 603 via the non-proprietary link layer connection 603. The reception component 604 may be configured to send a signal 609 associated with each of the received LL data PDUs to the determination component 606.

The determination component 606 may be configured to determine a duration of a previous non-proprietary link layer connection event. In certain aspects, the determination component 606 may be configured to determine the duration of the previous non-proprietary link layer connection event by determining a start time associated with the previous non-proprietary link layer connection event. In certain other aspects, the determination component 606 may be configured to determine the duration of the previous non-proprietary link layer connection event by determining a termination time associated with the previous non-proprietary link layer connection event based on a pair of link layer data PDUs that each include a more data field set to zero being exchanged. The determination component 606 may be configured to determine a number of proprietary link layer control PDUs to be exchanged during a proprietary connection event based at least in part on the duration of the previous non-proprietary link layer connection event and a start time of a subsequent non-proprietary link layer connection event. The determination component 606 may be configured to send a signal 611 including information associated with the duration of the LL connection event and/or the QLL connection event to the transmission component 610.

One or more of the reception component 604, the QLL control procedure component 608, and/or the transmission component 610 may be configured to perform a proprietary control procedure by exchanging the number of proprietary link layer PDUs with the second device during the proprietary connection event. In one aspect, the proprietary control procedure may include at least one of identifying a peer proprietary controller in the second device, determining proprietary channels, determining proprietary features supported by both the first device and the second device, performing a proprietary security management procedure, or terminating the proprietary link layer connection. When the proprietary control procedure is the proprietary security management procedure, one or more of the reception component 604, the QLL control procedure component 608, and/or the transmission component 610 may be configured to perform the proprietary control procedure by transmitting or receiving an encryption key challenge request PDU 605, 607. When the proprietary control procedure is the proprietary security management procedure, one or more of the reception component 604, the QLL control procedure component 608, and/or the transmission component 610 may be configured to perform the proprietary control procedure by receiving or transmitting an encryption key response PDU 605, 607. When the proprietary control procedure is the proprietary security management procedure, one or more of the reception component 604, the QLL control procedure component 608, and/or the transmission component 610 may be configured to perform the proprietary control procedure by transmitting or receiving an encryption key update PDU 605, 607. In certain aspects, the QLL control procedure component 608 may be configured to send a signal 615 associated with a QLL control PDU to the transmission component 610. In certain other aspects, the reception component 604 may be configured to send a signal 613 associated with a received QLL control PDU to the QLL control procedure component 608. The QLL control procedure component 608 may determine a subsequent QLL control PDU to be transmitted to the second device 650 based at least in part on the signal 613 received from the reception component 604.

When the proprietary link layer control procedure includes the terminating the proprietary link layer connection, one or more of the reception component 604, the QLL control procedure component 608, and/or the transmission component 610 may be configured to perform the proprietary control procedure by transmitting or receiving a proprietary link layer termination PDU 605, 607. One or more of the reception component 604 and/or the transmission component 610 may be configured to send a signal 613, 615 indicating the reception and/or transmission of a proprietary link layer termination PDU. The QLL control procedure component 608 may be configured to deallocate resources associated with the proprietary link layer connection.

The apparatus may include additional components that perform each of the blocks of the algorithm in the aforementioned flowcharts of FIGS. 5A and 5B. As such, each block in the aforementioned flowcharts of FIGS. 5A and 5B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

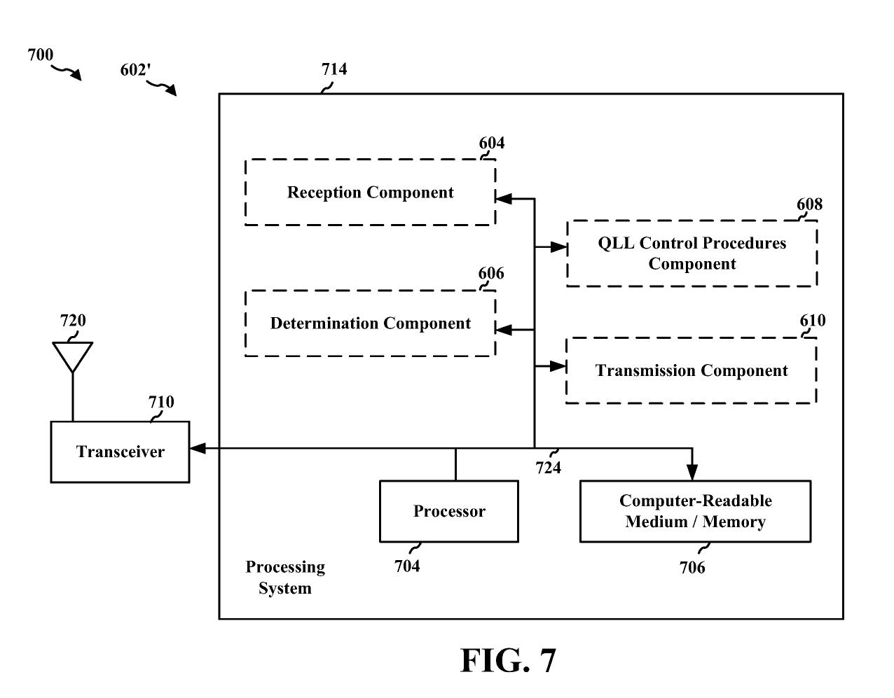

FIG. 7 is a diagram 700 illustrating an example of a hardware implementation for an apparatus 602′ employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware components, represented by the processor 704, the components 604, 606, 608, 610, and the computer-readable medium/memory 706. The bus 724 may also link various other circuits such as timing sources, peripherals, voltage regulators, and power management circuits, which are well known in the art, and therefore, will not be described any further.

The processing system 714 may be coupled to a transceiver 710. The transceiver 710 is coupled to one or more antennas 720. The transceiver 710 provides a means for communicating with various other apparatus over a transmission medium. The transceiver 710 receives a signal from the one or more antennas 720, extracts information from the received signal, and provides the extracted information to the processing system 714, specifically the reception component 604. In addition, the transceiver 710 receives information from the processing system 714, specifically the transmission component 610, and based on the received information, generates a signal to be applied to the one or more antennas 720. The processing system 714 includes a processor 704 coupled to a computer-readable medium/memory 706. The processor 704 is responsible for general processing, including the execution of software stored on the computer-readable medium/memory 706. The software, when executed by the processor 704, causes the processing system 714 to perform the various functions described supra for any particular apparatus. The computer-readable medium/memory 706 may also be used for storing data that is manipulated by the processor 704 when executing software. The processing system 714 further includes at least one of the components 604, 606, 608, 610. The components may be software components running in the processor 704, resident/stored in the computer readable medium/memory 706, one or more hardware components coupled to the processor 704, or some combination thereof.

In certain configurations, the apparatus 602/602′ for wireless communication may include means for establishing a non-proprietary short-range link layer connection with a second device. In certain other configurations, the apparatus 602/602′ for wireless communication may include means for establishing a proprietary link layer connection with the second device.

In certain other configurations, the apparatus 602/602′ for wireless communication may include means for determining a duration of a previous non-proprietary link layer connection event. In certain aspects, the means for determining the duration of the previous non-proprietary link layer connection event may be configured to determine a start time associated with the previous non-proprietary link layer connection event. In certain other aspects, the means for determining the duration of the previous non-proprietary link layer connection event may be configured to determine a termination time associated with the previous non-proprietary link layer connection event based on a pair of link layer data PDUs that each include a more data field set to zero being exchanged.

In certain other configurations, the apparatus 602/602′ for wireless communication may include means for determining a number of proprietary link layer control PDUs to be exchanged during a proprietary connection event based at least in part on the duration of the previous non-proprietary link layer connection event and a start time of a subsequent non-proprietary link layer connection event.

In certain other configurations, the apparatus 602/602′ for wireless communication may include means for performing a proprietary control procedure. The means for performing the proprietary control procedure may be configured to exchange the number of proprietary link layer PDUs with the second device during the proprietary connection event. In one aspect, the proprietary control procedure may include at least one of identifying a peer proprietary controller in the second device, determining proprietary channels, determining proprietary features supported by both the first device and the second device, performing a proprietary security management procedure, or terminating the proprietary link layer connection.

When the proprietary control procedure is the proprietary security management procedure, the means for performing a proprietary control procedure may be configured to transmit or receive an encryption key challenge request PDU. When the proprietary control procedure is the proprietary security management procedure, the means for performing a proprietary control procedure may be configured to receive or transmit an encryption key response PDU. When the proprietary control procedure is the proprietary security management procedure, the means for performing a proprietary control procedure may be configured to transmit or receive an encryption key update PDU.

When the proprietary link layer control procedure includes the terminating the proprietary link layer connection, the means for performing a proprietary control procedure may be configured to transmit or receive a proprietary link layer termination PDU.

In certain other configurations, the apparatus 602/602′ for wireless communication may include means for deallocate resources associated with the proprietary link layer connection.

The aforementioned means may be one or more of the aforementioned processor(s) 202, short-range communications controller 252, the proprietary controller 256, and/or radio 230 in FIG. 2, components of the apparatus 602 and/or the processing system 714 of the apparatus 602′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a first device, comprising:
establishing a non-proprietary short-range link layer connection with a second device;
establishing a proprietary link layer connection with the second device;
determining a duration of a previous non-proprietary link layer connection event;
determining a number of proprietary link layer control protocol data units (PDUs) to be exchanged during a proprietary connection event based at least in part on the duration of the previous non-proprietary link layer connection event and a start time of a subsequent non-proprietary link layer connection event; and
performing a proprietary control procedure by exchanging the number of proprietary link layer PDUs with the second device during the proprietary connection event.

2. The method of claim 1, wherein the proprietary control procedure includes at least one of identifying a peer proprietary controller in the second device, determining proprietary channels, determining proprietary features supported by both the first device and the second device, performing a proprietary security management procedure, or terminating the proprietary link layer connection.

3. The method of claim 2, wherein when the performing the proprietary control procedure is the proprietary security management procedure, the performing the proprietary control procedure comprises:
transmitting or receiving an encryption key challenge request PDU;
receiving or transmitting an encryption key response PDU; and
transmitting or receiving an encryption key update PDU.

4. The method of claim 3, wherein the encryption key update PDU includes information associated with a new encryption key and a subsequent proprietary link layer connection event in which to use the new encryption key.

5. The method of claim 2, wherein when the proprietary link layer control procedure includes the terminating the proprietary link layer connection, the performing the proprietary link layer control procedure comprises:
transmitting or receiving a proprietary link layer termination PDU; and
deallocating resources associated with the proprietary link layer connection.

6. The method of claim 1, wherein the determining the duration of the previous non-proprietary link layer connection event comprises:
determining a start time associated with the previous non-proprietary link layer connection event; and
determining a termination time associated with the previous non-proprietary link layer connection event based on a pair of link layer data PDUs that each include a more data field set to zero being exchanged.

7. An apparatus for wireless communication of a first device, comprising:
means for establishing a non-proprietary short-range link layer connection with a second device;
means for establishing a proprietary link layer connection with the second device;
means for determining a duration of a previous non-proprietary link layer connection event;
means for determining a number of proprietary link layer control protocol data units (PDUs) to be exchanged during a proprietary connection event based at least in part on the duration of the previous non-proprietary link layer connection event and a start time of a subsequent non-proprietary link layer connection event; and
means for performing a proprietary control procedure by exchanging the number of proprietary link layer PDUs with the second device during the proprietary connection event.

8. The apparatus of claim 7, wherein the proprietary control procedure includes at least one of identifying a peer proprietary controller in the second device, determining proprietary channels, determining proprietary features supported by both the first device and the second device, performing a proprietary security management procedure, or terminating the proprietary link layer connection.

9. The apparatus of claim 8, wherein when the performing the proprietary control procedure is the proprietary security management procedure, the means for performing the proprietary control procedure is configured to:
transmit or receive an encryption key challenge request PDU;
receive or transmit an encryption key response PDU; and
transmit or receive an encryption key update PDU.

10. The apparatus of claim 9, wherein the encryption key update PDU includes information associated with a new encryption key and a subsequent proprietary link layer connection event in which to use the new encryption key.

11. The apparatus of claim 8, wherein when the proprietary link layer control procedure includes the terminating the proprietary link layer connection, the means for performing proprietary link layer control procedure is configured to:
transmit or receive a proprietary link layer termination PDU; and
deallocate resources associated with the proprietary link layer connection.

12. The apparatus of claim 7, wherein the means for determining the duration of the previous non-proprietary link layer connection event is configured to:
determine a start time associated with the previous non-proprietary link layer connection event; and
determine a termination time associated with the previous non-proprietary link layer connection event based on a pair of link layer data PDUs that each include a more data field set to zero being exchanged.

13. An apparatus for wireless communication of a first device, comprising:
a memory; and
at least one processor coupled to the memory and configured to:
establish a non-proprietary short-range link layer connection with a second device;
establish a proprietary link layer connection with the second device;
determine a duration of a previous non-proprietary link layer connection event;
determine a number of proprietary link layer control protocol data units (PDUs) to be exchanged during a proprietary connection event based at least in part on the duration of the previous non-proprietary link layer connection event and a start time of a subsequent non-proprietary link layer connection event; and
perform a proprietary control procedure by exchanging the number of proprietary link layer PDUs with the second device during the proprietary connection event.

14. The apparatus of claim 13, wherein the proprietary control procedure includes at least one of identifying a peer proprietary controller in the second device, determining proprietary channels, determining proprietary features supported by both the first device and the second device, performing a proprietary security management procedure, or terminating the proprietary link layer connection.

15. The apparatus of claim 14, wherein when the performing the proprietary control procedure is the proprietary security management procedure, the at least one processor is configured to perform the proprietary control procedure by:
transmitting or receiving an encryption key challenge request PDU;
receiving or transmitting an encryption key response PDU; and
transmitting or receiving an encryption key update PDU.

16. The apparatus of claim 15, wherein the encryption key update PDU includes information associated with a new encryption key and a subsequent proprietary link layer connection event in which to use the new encryption key.

17. The apparatus of claim 14, wherein when the proprietary link layer control procedure includes the terminating the proprietary link layer connection, the at least one processor is configured to perform the proprietary link layer control procedure by:
transmitting or receiving a proprietary link layer termination PDU; and
deallocating resources associated with the proprietary link layer connection.

18. The apparatus of claim 13, wherein the at least one processor is configured to determine the duration of the previous non-proprietary link layer connection event by:
determining a start time associated with the previous non-proprietary link layer connection event; and
determining a termination time associated with the previous non-proprietary link layer connection event based on a pair of link layer data PDUs that each include a more data field set to zero being exchanged.

19. A computer-readable medium storing computer executable code for a first device, comprising code to:
establish a non-proprietary short-range link layer connection with a second device;
establish a proprietary link layer connection with the second device;
determine a duration of a previous non-proprietary link layer connection event;
determine a number of proprietary link layer control protocol data units (PDUs) to be exchanged during a proprietary connection event based at least in part on the duration of the previous non-proprietary link layer connection event and a start time of a subsequent non-proprietary link layer connection event; and
perform a proprietary control procedure by exchanging the number of proprietary link layer PDUs with the second device during the proprietary connection event.

20. The computer-readable medium of claim 19, wherein the proprietary control procedure includes at least one of identifying a peer proprietary controller in the second device, determining proprietary channels, determining proprietary features supported by both the first device and the second device, performing a proprietary security management procedure, or terminating the proprietary link layer connection.

21. The computer-readable medium of claim 20, wherein when the performing the proprietary control procedure is the proprietary security management procedure, the code to perform the proprietary control procedure is configured to:
transmit or receive an encryption key challenge request PDU;
receive or transmit an encryption key response PDU; and
transmit or receive an encryption key update PDU.

22. The computer-readable medium of claim 21, wherein the encryption key update PDU includes information associated with a new encryption key and a subsequent proprietary link layer connection event in which to use the new encryption key.

23. The computer-readable medium of claim 20, wherein when the proprietary link layer control procedure includes the terminating the proprietary link layer connection, the code to perform the proprietary link layer control procedure is configured to:
transmit or receive a proprietary link layer termination PDU; and
deallocate resources associated with the proprietary link layer connection.

24. The computer-readable medium of claim 19, wherein the code to determine the duration of the previous non-proprietary link layer connection event is configured to:
determine a start time associated with the previous non-proprietary link layer connection event; and
determine a termination time associated with the previous non-proprietary link layer connection event based on a pair of link layer data PDUs that each include a more data field set to zero being exchanged.
